(19) United States
(12) Patent Application Publication
(10) Pub. No.: US 2026/0178250 A1
(43) Pub. Date: Jun. 25, 2026

(54) INFORMATION PROCESSING SYSTEM, INFORMATION PROCESSING DEVICE, INFORMATION PROCESSING METHOD, AND RECORDING MEDIUM

(71) Applicant: Mitsubishi Electric Corporation, Tokyo (JP)

(72) Inventors: Shun KATO, Tokyo (JP); Hirotoshi YANO, Tokyo (JP)

(21) Appl. No.: 19/124,147

(22) PCT Filed: Mar. 14, 2023
(86) PCT No.: PCT/JP2023/009834

§ 371 Date: Apr. 24, 2025

(51) Int. Cl. G06F 3/12

(52) U.S. Cl. CPC G06F 3/1239; G06F 3/1211

(57) ABSTRACT

An information processing system includes an air conditioning unit information acquisition unit that acquires air conditioning unit information acquired from a refrigeration cycle device having indoor circuitry fixed inside a building and outdoor circuitry fixed outside the building, storage circuitry that stores a reference range of data for each air conditioning unit information, reception circuitry to receive disaster information for notifying that a disaster is occurring at a location at which the refrigeration cycle device is installed, determination circuitry to determine, in a case where the disaster information is received by the reception circuitry, whether the acquired air conditioning unit information is data included in the reference range stored in the storage circuitry to estimate damage information of the refrigeration cycle device and the inside of the building, and determine a notification content, and notification circuitry to provide notification of the notification content determined by the determination circuitry.

### TECHNICAL FIELD

The present disclosure relates to an information processing system, an information processing device, an information processing method, and a program.

### BACKGROUND ART

As an information processing system in the related art, there is a disaster situation notification system disclosed in Patent Document 1. In the disaster situation notification system disclosed in Patent Document 1, in a case where disaster occurrence information indicating that a disaster is occurring in a region in which an air purifier is installed is received from an external server, the disaster situation notification system estimates an effect of the disaster on a space in which an air conditioner is installed, based on detection information acquired from a sensor unit provided in the air purifier after the disaster occurs.

### CITATION LIST

### Patent Document

Patent Document 1: Japanese Unexamined Patent Application, First Publication No. 2020-136771

### SUMMARY OF INVENTION

### Technical Problem

However, an information processing system disclosed in Patent Document 1 includes an air purifier including a sensor unit that acquires detection information. Since the air purifier is portable, it is considered that an installation location is not fixed and the location is moved. Therefore, there is a problem that there is a possibility that accuracy of the estimated information is low due to inaccuracy of the detection information acquired by the sensor unit and information on the installation location registered in advance.

The present disclosure has been made in order to solve the problem described above, and an object of the present disclosure is to provide an information processing system, an information processing device, an information processing method, and a program that improve the accuracy of estimated information than the information processing system disclosed in Patent Document 1.

### Solution to Problem

According to the present disclosure, an information processing system includes: a refrigeration cycle device information acquisition unit to acquire refrigeration cycle device information acquired from a refrigeration cycle device having an indoor unit fixed inside a building and an outdoor unit fixed outside the building; a storage unit to store a reference range of data for each refrigeration cycle device information; a reception unit to receive disaster information for notifying that a disaster is occurring at a location at which the refrigeration cycle device is installed; a determination unit to determine, in a case where the disaster information is received by the reception unit, whether the acquired refrigeration cycle device information is data included in the reference range stored in the storage unit to estimate damage information of the refrigeration cycle device and the inside of the building, and determine a notification content; and a notification unit to provide notification of the notification content determined by the determination unit.

In addition, according to the present disclosure, an information processing device includes: a reception unit to receive disaster information for notifying that a disaster is occurring at a location at which a refrigeration cycle device including an indoor unit fixed inside a building and an outdoor unit fixed outside the building is installed, and refrigeration cycle device information acquired from the refrigeration cycle device; a storage unit to store a value indicating a reference range of data for each refrigeration cycle device information; a determination unit to determine whether the disaster information and the refrigeration cycle device information received by the reception unit are data included in the reference range stored in the storage unit to estimate damage information of the refrigeration cycle device and the inside of the building, and determine a notification content; and a transmission unit to transmit a signal for providing notification of the notification content determined by the determination unit, to a notification unit that provides notification of the notification content.

In addition, according to the present disclosure, an information processing method includes: a first step of determining, in a case where disaster information for notifying that a disaster is occurring is issued, whether refrigeration cycle device information acquired from a refrigeration cycle device having an indoor unit fixed inside a building and an outdoor unit fixed outside the building is data included in a reference range stored in a storage unit to estimate damage information of the refrigeration cycle device and the inside of the building, and determining a notification content, by a determination unit; and a second step of providing notification of the notification content determined in the first step, by a notification unit.

In addition, according to the present disclosure, a program causes a computer to execute: a first step of determining, in a case where disaster information for notifying that a disaster is occurring is issued, whether refrigeration cycle device information acquired from a refrigeration cycle device having an indoor unit fixed inside a building and an outdoor unit fixed outside the building is data included in a reference range stored in a storage unit to estimate damage information of the refrigeration cycle device and the inside of the building, and determining a notification content, by a determination unit; and a second step of providing notification of the notification content determined in the first step, by a notification unit.

### Advantageous Effects of Invention

An information processing system, an information processing device, an information processing method, and a program according to the present disclosure achieve an effect of improving accuracy of damage information of a refrigeration cycle device and the inside of a building, which is estimated information.

### BRIEF DESCRIPTION OF DRAWINGS

FIG. 1 A schematic diagram of a damage information detection system according to Embodiment 1.

FIG. 2 A refrigerant circuit diagram showing an outline of a refrigeration cycle device included in the damage information detection system according to Embodiment 1.

FIG. 3 A block diagram showing a hardware configuration of the damage information detection system according to Embodiment 1.

FIG. 4 A block diagram showing a functional configuration of the damage information detection system according to Embodiment 1.

FIG. 5 A diagram showing refrigeration cycle device information acquired in Embodiment 1.

FIG. 6 A diagram showing a reference range of other refrigeration cycle device information corresponding to a voltage value of a motor in an outdoor air blowing device, which is primary reference data stored in a damage information detection device-side storage unit included in the damage information detection system according to Embodiment 1.

FIG. 7 A flowchart showing a process performed by the damage information detection device included in the damage information detection system according to Embodiment 1.

FIG. 8 A diagram showing an example of a screen on which damage information is notified to a notification unit of a mobile terminal included in the damage information detection system according to Embodiment 1.

FIG. 9 A flowchart showing a process performed by a damage information detection device included in a damage information detection system according to a modification example of Embodiment 1.

FIG. 10 A block diagram showing a hardware configuration of a damage information detection system according to Embodiment 2.

FIG. 11 A flowchart showing a process performed by a damage information detection device included in the damage information detection system according to Embodiment 2.

FIG. 12 A diagram showing an example of a screen on which damage information is notified to a notification unit of a mobile terminal included in the damage information detection system according to Embodiment 2.

FIG. 13 A flowchart showing a process performed by a damage information detection device included in a damage information detection system according to Embodiment 3.

FIG. 14 A flowchart showing an inundation estimation process and an inundation damage amount calculation process of each home appliance according to Embodiment 3.

FIG. 15 A diagram showing an example of a screen on which damage information is notified to a notification unit of a mobile terminal included in the damage information detection system according to Embodiment 3.

FIG. 16 A block diagram showing a functional configuration of a damage information detection system according to Embodiment 4.

FIG. 17 A flowchart showing a process performed by a damage information detection device included in the damage information detection system according to Embodiment 4.

FIG. 18 A configuration diagram of a learning device and a learned model storage unit incorporated in a damage information detection device in a damage information detection system according to Embodiment 5.

FIG. 19 A flowchart related to a learning process of the learning device in the damage information detection system according to Embodiment 5.

FIG. 20 A configuration diagram of an inference device in the damage information detection system according to Embodiment 5.

FIG. 21 A flowchart showing an inference process of the inference device in the damage information detection system according to Embodiment 5.

### DESCRIPTION OF EMBODIMENTS

In embodiments of the present disclosure, a damage information detection system, which is an example of an information processing system, will be described. The present disclosure can also be applied to an information processing system other than the damage information detection system, and can be modified or omitted without departing from the gist of the present disclosure. In addition, the same reference numerals are assigned to common elements in each drawing, and the description thereof will not be repeated.

### Embodiment 1

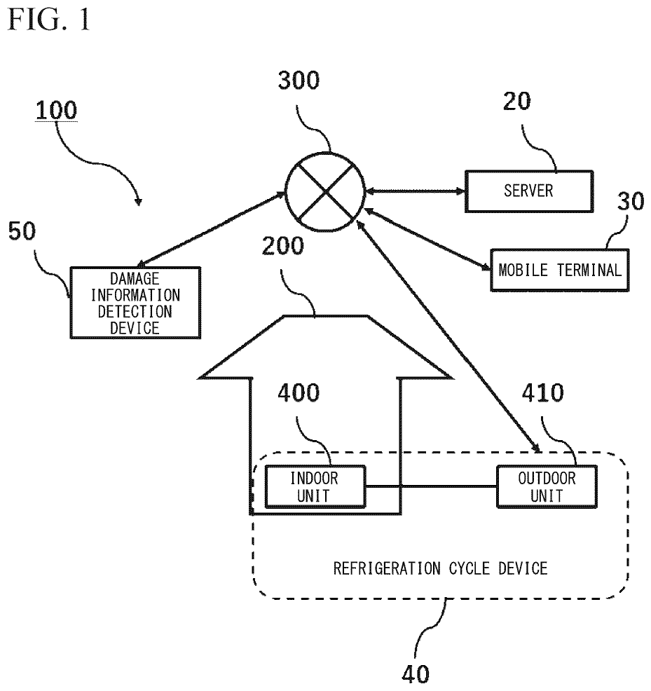

FIG. 1 is a schematic diagram of a damage information detection system according to Embodiment 1. An outline of the damage information detection system will be described with reference to FIG. 1. A damage information detection system 100 includes a server 20, a mobile terminal 30, a refrigeration cycle device 40, and a damage information detection device 50. In addition, a building 200 and a network 300 shown in FIG. 1 are described for the sake of description, and are not included in the damage information detection system 100.

The server 20, the mobile terminal 30, the refrigeration cycle device 40, and the damage information detection device 50 are connected to each other via the network 300. A LAN, a WAN, the Internet, Bluetooth (registered trademark), a dedicated circuit, infrared communication, and the like are exemplary examples of the network 300.

The server 20 registers a combination of identification information of the refrigeration cycle device 40 and identification information of the mobile terminal 30. In addition, the server 20 acquires disaster information for notifying that a disaster is occurring at a location at which the refrigeration cycle device 40 registered in advance is installed. The disaster information includes information on a natural disaster, such as earthquake information, volcanic eruption information, sediment disaster information, heavy snowfall information, storm surge information, heavy rain information, flood information, tsunami information, typhoon information, and tornado information, and includes information on a human disaster such as occurrence of fire or riot. In addition, the server 20 acquires evacuation information for notifying a user of evacuation in the location at which the refrigeration cycle device 40 is installed, which is registered in advance.

The mobile terminal 30 is a terminal that is owned and carried by the user, such as a tablet terminal or a smartphone. An application capable of performing pre-registration of an installation location of the refrigeration cycle device 40, that is, a location of the building 200, and receiving and displaying damage information generated by the damage information detection system 100 is installed in the mobile terminal 30. By using the application, the damage information can be received in a case where the user is outside a house, and thus damage information detection can be performed more effectively.

The refrigeration cycle device 40 includes an indoor unit 400 fixed in an indoor space and an outdoor unit 410 fixed in an outdoor place. In addition, devices constituting the refrigeration cycle device are connected to each other by a pipe 301 to be described below, and a refrigerant circuit through which a refrigerant is circulated is formed in the refrigeration cycle device 40. The refrigeration cycle device 40 is generally used without being moved once fixed.

The damage information detection device 50 is an information processing device that detects damage information of the refrigeration cycle device 40 from refrigeration cycle device information acquired from the refrigeration cycle device 40 in a case where disaster information is received from the server 20.

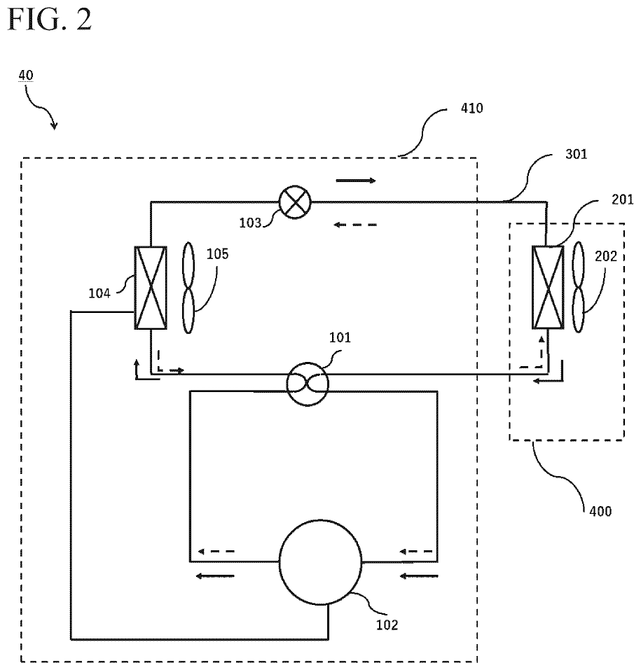

FIG. 2 is a refrigerant circuit diagram showing an outline of the refrigeration cycle device 40 according to Embodiment 1. A specific configuration of the refrigeration cycle device 40 will be described with reference to FIG. 2.

As shown in FIG. 2, the refrigeration cycle device 40 includes the indoor unit 400 and the outdoor unit 410. In FIG. 2, a flow of refrigerant during a heating operation in the refrigeration cycle device 40 is indicated by a broken line arrow, and a flow of the refrigerant during a cooling operation is indicated by a solid line arrow.

The indoor unit 400 is connected to an indoor heat exchanger 201 that functions as an evaporator during the cooling operation and functions as a condenser during the heating operation, and an indoor air blowing device 202 that blows an indoor air to the indoor heat exchanger 201, through the pipe 301. The indoor air blowing device 202 includes a fan and a motor.

The outdoor unit 410 is formed by communicating a four-way valve 101 that switches between a refrigerant circuit in the heating operation and a refrigerant circuit in the cooling operation, a compressor 102 that compresses the refrigerant, a decompression device 103 that decompresses the refrigerant, an outdoor heat exchanger 104 that functions as a condenser in the cooling operation and functions as an evaporator in the heating operation, and an outdoor air blowing device 105 that blows an outdoor air to the outdoor heat exchanger 104, through the pipe 301. Specifically, the decompression device 103 is an expansion valve. The outdoor air blowing device 105 includes a fan and a motor.

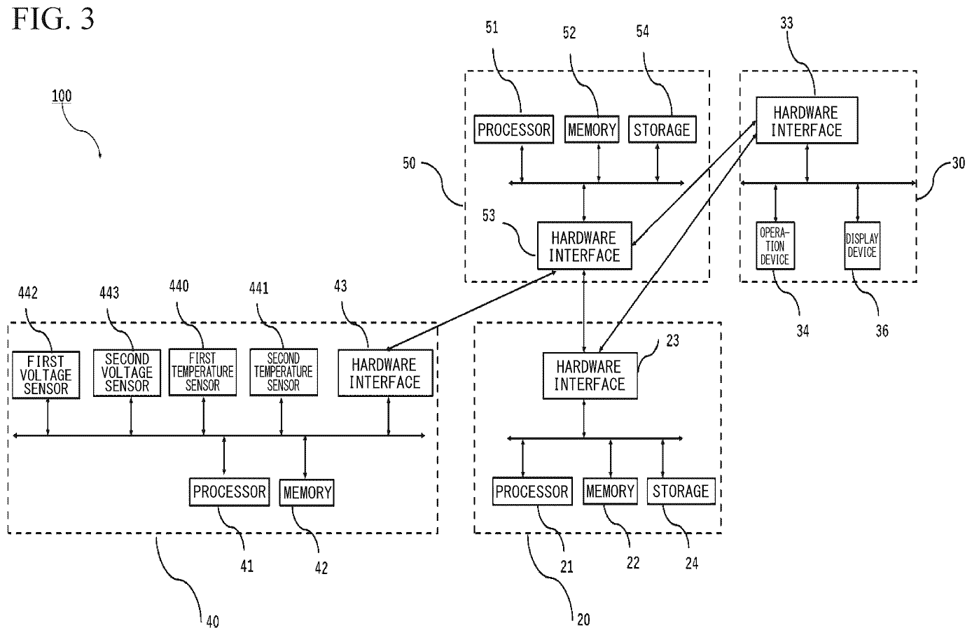

FIG. 3 is a block diagram showing a hardware configuration of the damage information detection system 100 according to Embodiment 1. Next, the hardware configuration of the damage information detection system 100 will be described with reference to FIG. 3.

The server 20 includes a processor 21, a memory 22, a hardware interface 23, and a storage 24. The processor 21 executes a program stored in the memory 22. The processor 21 acquires, for example, damage information. The processor 21 is, for example, a central processing unit (CPU). The memory 22 stores the program to be executed by the processor 21. In addition, the memory 22 is used as a work region of the processor 21. The memory 22 is, for example, a volatile memory such as a random access memory (RAM), a non-volatile memory such as a read only memory (ROM), or both the volatile memory and the non-volatile memory. The hardware interface 23 transmits or receives a signal to or from a hardware interface 53 of the damage information detection device 50 in a wireless or wired manner. The storage 24 stores information indicating a combination of identification information of the refrigeration cycle device 40 and identification information of the mobile terminal 30 and acquired damage information. The storage 24 is, for example, a solid state drive (SSD) or a hard disk.

The mobile terminal 30 includes a hardware interface 33, an operation device 34, and a display device 36. The hardware interface 33 transmits or receives a signal to or from the hardware interface 23 of the server 20 and the hardware interface 53 of the damage information detection device 50 in a wireless or wired manner. The operation device 34 receives an operation from a user. The display device 36 displays information to the user. In Embodiment 1, the operation device 34 and the display device 36 are integrated by a touch panel.

The refrigeration cycle device 40 includes a processor 41, a memory 42, a hardware interface 43, a first temperature sensor 440, a second temperature sensor 441, a first voltage sensor 442, and a second voltage sensor 443. The processor 41 executes a program stored in the memory 42. The processor 41 controls an operation of the refrigeration cycle device 40, for example. The memory 42 stores the program to be executed by the processor 41. The hardware interface 43 transmits or receives a signal to or from the hardware interface 53 of the damage information detection device 50 in a wireless or wired manner. The first temperature sensor 440 detects the temperature of a refrigerant discharged from the compressor 102. The second temperature sensor 441 detects the temperature of the refrigerant in the pipe 301 between the decompression device 103 and the outdoor heat exchanger 104. The first voltage sensor 442 acquires a voltage value of the motor in the outdoor air blowing device 105. The second voltage sensor 443 acquires a voltage value of the motor in the indoor air blowing device 202.

The damage information detection device 50 includes a processor 51, a memory 52, a hardware interface 53, and a storage 54. The processor 51 executes a program stored in the memory 52. The processor 51 estimates damage information of the refrigeration cycle device 40 from, for example, damage information and refrigeration cycle device information, and determines a notification content to the user. The memory 52 stores the program to be executed by the processor 51. The hardware interface 53 transmits or receives a signal to or from the hardware interface 23 of the server 20, the hardware interface 33 of the mobile terminal 30, and the hardware interface 43 of the refrigeration cycle device 40 in a wireless or wired manner. The storage 54 stores acquired refrigeration cycle device information.

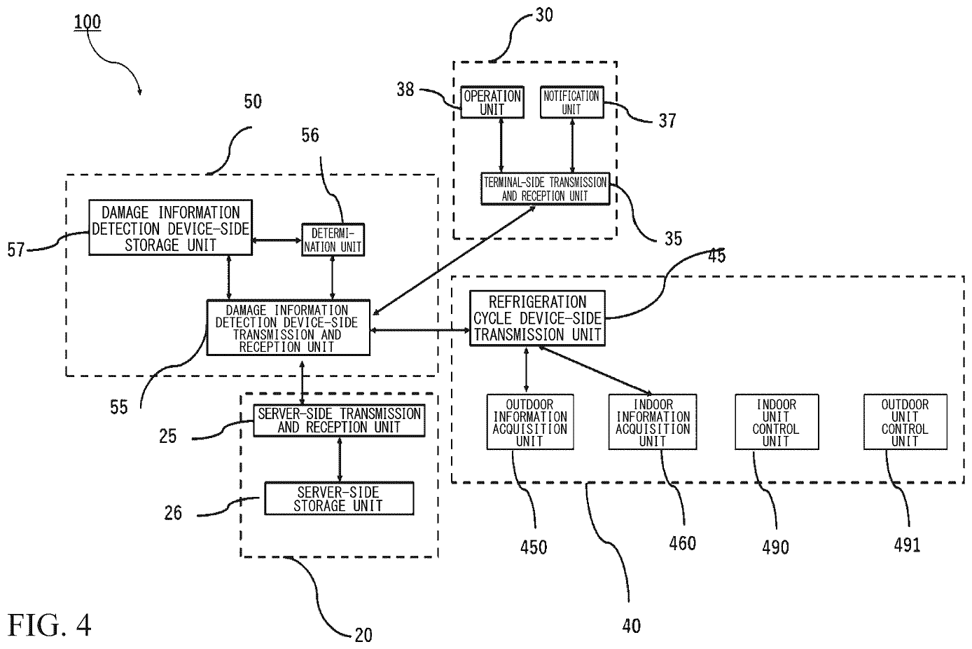

FIG. 4 is a block diagram showing a functional configuration of a damage information detection system according to Embodiment 1. A functional configuration of the damage information detection system 100 will be described with reference to FIG. 4.

The server 20 includes a server-side transmission and reception unit 25 and a server-side storage unit 26.

The server-side transmission and reception unit 25 transmits a signal from the server 20, or receives a signal to the server 20. Specifically, the server-side transmission and reception unit 25 receives information indicating a combination of the refrigeration cycle device 40 and the mobile terminal 30, damage information, and evacuation information. In addition, in a case of acquiring damage information including a location of the building 200 that is registered in advance, the server-side transmission and reception unit 25 transmits the acquired damage information to the damage information detection device 50 each time. The server-side transmission and reception unit 25 is realized by the hardware interface 23 of the server 20.

The server-side storage unit 26 stores information indicating a combination of identification information of the refrigeration cycle device 40 and identification information of the mobile terminal 30 and the acquired damage information. In addition, the user pre-registers the location of the building 200 by inputting information on the address of the building 200 to the mobile terminal 30 before start of use of the system. The server-side storage unit 26 receives pre-registration information from the mobile terminal 30, and stores the information on the pre-registration. That is, the user can acquire the required damage information from a plurality of pieces of damage information, by using an association between the identification information of the refrigeration cycle device 40 and the identification information of the mobile terminal 30. The server-side storage unit 26 is realized by storing various types of information in the storage 24 of the server 20.

The mobile terminal 30 includes a terminal-side transmission and reception unit 35, a notification unit 37, and an operation unit 38.

The terminal-side transmission and reception unit 35 receives a signal to the mobile terminal 30. Specifically, the terminal-side transmission and reception unit 35 receives damage information of the refrigeration cycle device 40 determined by the damage information detection device 50. In addition, the terminal-side transmission and reception unit 35 transmits information obtained by pre-registering the installation location of the refrigeration cycle device 40 to the server 20 before start of use of the system. The terminal-side transmission and reception unit 35 is realized by the hardware interface 33 of the mobile terminal 30.

The notification unit 37 notifies the user of the damage information of the refrigeration cycle device 40 received by the terminal-side transmission and reception unit 35. The notification unit 37 is realized by the display device 36.

The operation unit 38 inputs a content of the pre-registration by the user. The content input by the operation unit 38 is transmitted to the terminal-side transmission and reception unit 35, and then stored in the server-side storage unit 26. The operation unit 38 is realized by the operation device 34.

The refrigeration cycle device 40 includes an outdoor information acquisition unit 450, an indoor information acquisition unit 460, an indoor unit control unit 490, an outdoor unit control unit 491, and a refrigeration cycle device-side transmission unit 45.

The outdoor information acquisition unit 450 acquires outdoor information indicating outdoor information of the building 200 in which the refrigeration cycle device 40 is installed. More specifically, the outdoor information acquisition unit 450 acquires the temperature of a refrigerant discharged from the compressor 102, the temperature of the refrigerant in the pipe 301 between the decompression device 103 and the outdoor heat exchanger 104, and a voltage of the motor in the outdoor air blowing device 105. The outdoor information acquisition unit 450 is realized by the first temperature sensor 440, the second temperature sensor 441, and the first voltage sensor 442 of the refrigeration cycle device 40.

The indoor information acquisition unit 460 acquires indoor information indicating information on the inside of the building 200 in which the refrigeration cycle device 40 is installed. More specifically, the indoor information acquisition unit 460 acquires a voltage of the motor in the indoor air blowing device 202. The indoor information acquisition unit 460 is realized by the second voltage sensor 443 of the refrigeration cycle device 40. In Embodiment 1, since both the outdoor information and the indoor information are acquired, the reliability of estimated damage information is higher than in a case where only the outdoor information is acquired or only the indoor information is acquired.

The indoor unit control unit 490 controls each device constituting the indoor unit 400. The outdoor unit control unit 491 controls each device constituting the outdoor unit 410. The indoor unit control unit 490 and the outdoor unit control unit 491 are realized by the processor 41 and the memory 42 of the refrigeration cycle device 40.

The refrigeration cycle device-side transmission unit 45 acquires refrigeration cycle device information from the outdoor information acquisition unit 450 and the indoor information acquisition unit 460, and transmits the refrigeration cycle device information to the damage information detection device 50. The refrigeration cycle device-side transmission unit 45 is realized by the hardware interface 43 of the refrigeration cycle device 40.

The damage information detection device 50 includes a damage information detection device-side transmission and reception unit 55, a determination unit 56, and a damage information detection device-side storage unit 57.

The damage information detection device-side transmission and reception unit 55 transmits a signal from the damage information detection device 50, or receives a signal to the damage information detection device 50. Specifically, the damage information detection device-side transmission and reception unit 55 receives refrigeration cycle device information from the refrigeration cycle device 40 and damage information from the server 20. In addition, the damage information detection device-side transmission and reception unit 55 transmits a notification content determined by the determination unit 56 to the notification unit 37 of the mobile terminal 30. The damage information detection device-side transmission and reception unit 55 is realized by the hardware interface 53 of the damage information detection device 50.

The determination unit 56 determines the notification content to be notified by the notification unit 37. In a case where disaster information is received from the server 20, the determination unit 56 determines whether refrigeration cycle device information is data in a reference range stored in the damage information detection device-side storage unit 57. The determination unit 56 estimates damage information for the refrigeration cycle device 40 and a space in which the refrigeration cycle device 40 is installed, that is, damage information of the inside of the building 200, based on the determination, and determines the notification content. More specifically, the determination unit 56 uses one refrigeration cycle device information of the received refrigeration cycle device information as primary reference data, and determines that the damage information of the refrigeration cycle device 40 is undeterminable in a case where it is determined that the primary reference data is not included in the reference range. In Embodiment 1, the primary reference data is a voltage value of the motor in the outdoor air blowing device 105. In addition, in a case where it is determined that the primary reference data is included in the reference range, the determination unit 56 determines whether refrigeration cycle device information other than the primary reference data is included in a reference range determined by a value of the primary reference data to estimate the damage information of the refrigeration cycle device 40, and determines the notification content. In addition, in a case where the refrigeration cycle device information is not included in the reference range, the determination unit 56 estimates that the house is damaged. This is because it is considered that the house is also damaged in a case where the refrigeration cycle device 40 is damaged. The determination unit 56 is realized by the processor 51 and the memory 52 of the damage information detection device 50.

The damage information detection device-side storage unit 57 stores a value indicating the reference range of data for each refrigeration cycle device information. In addition, the damage information detection device-side storage unit 57 stores the refrigeration cycle device information received from the refrigeration cycle device 40. The damage information detection device-side storage unit 57 stores reference ranges of primary reference data and secondary reference data corresponding to the primary reference data. In Embodiment 1, the primary reference data is a voltage value of the motor in the outdoor air blowing device 105. In addition, the secondary reference data is the temperature of a refrigerant discharged from the compressor 102, the temperature of the refrigerant in the pipe between the decompression device 103 and the outdoor heat exchanger 104, and a voltage of the motor in the indoor air blowing device 202. The damage information detection device-side storage unit 57 is realized by storing various types of information in the storage 54 of the damage information detection device 50.

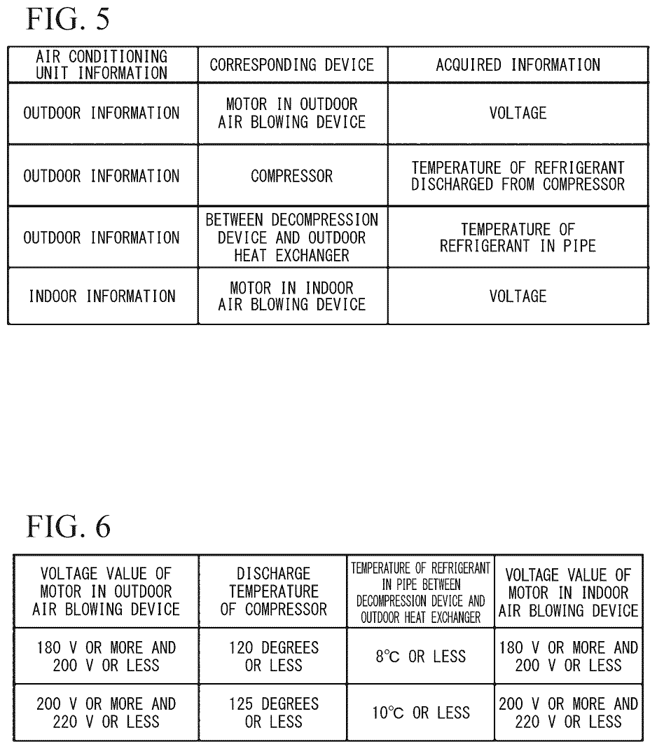

FIG. 5 is a diagram showing refrigeration cycle device information acquired in Embodiment 1. In addition, FIG. 6 is a diagram showing a reference range of other refrigeration cycle device information corresponding to a voltage value of the motor in the outdoor air blowing device 105, which is primary reference data, stored in the damage information detection device-side storage unit 57 included in the damage information detection system according to Embodiment 1. An example of a determination process performed by the determination unit 56 will be described with reference to FIGS. 5 and 6.

In a case where refrigeration cycle device information and damage information are received, the determination unit 56 performs a primary determination as to whether primary reference data in the refrigeration cycle device information is included in the reference range. In Embodiment 1, the primary reference data is a voltage value of the motor in the outdoor air blowing device 105. This is because data of the refrigeration cycle device 40 cannot be correctly acquired in a case where the voltage value of the motor in the outdoor air blowing device 105 is significantly different from a rated voltage value. In addition, the reference range of the primary reference data is stored in the damage information detection device-side storage unit 57. In Embodiment 1, the reference range of the voltage value of the motor in the outdoor air blowing device 105 is a range that is more than 180 V and less than 220 V.

In a case where an average value of the voltage values detected from the motor in the outdoor air blowing device 105, which is the primary reference data, is 180 V or less or 220 V or more, the determination unit 56 determines that the damage information of the refrigeration cycle device 40 cannot be estimated and the determination is unavailable. In a case where it is determined that the determination is unavailable, the determination unit 56 transmits a signal for causing the notification unit 37 to display that the determination is unavailable, to the damage information detection device-side transmission and reception unit 55.

In addition, in a case where the average value of the voltage values detected from the motor in the outdoor air blowing device 105, which is primary reference data, is more than 180 V and less than 220 V, the determination unit 56 performs a secondary determination as to whether refrigeration cycle device information other than the primary reference data, which is secondary reference data, is within a reference range. In the secondary determination, it is determined whether all the secondary reference data are within the reference range. In a case where it is determined that one or more pieces of secondary reference data are not within the reference range, the determination unit 56 estimates that the refrigeration cycle device 40 is damaged. This is because it is considered that the refrigeration cycle device 40 receives any damage due to a disaster in a case where even part of the secondary reference data is not included in the reference range. In a case where the refrigeration cycle device 40 is estimated to be damaged, the determination unit 56 estimates that the inside of the building 200 in which the indoor unit 400 of the refrigeration cycle device 40 is installed is also damaged. In a case where it is determined that one or more pieces of secondary reference data are not within the reference range, the determination unit 56 transmits a signal for causing the notification unit 37 to display that the refrigeration cycle device 40 and the space in which the refrigeration cycle device 40 is installed, that is, the inside of the building 200 is damaged, to the damage information detection device-side transmission and reception unit 55. In addition, in a case where it is determined that all the secondary reference data are within the reference range, the determination unit 56 transmits a signal for causing the notification unit 37 to display that the refrigeration cycle device 40 and the building 200 are not damaged, to the damage information detection device-side transmission and reception unit 55. In addition, the reference range of the secondary reference data is stored in the damage information detection device-side storage unit 57. In addition, a threshold value of the secondary reference data varies depending on the value of the primary reference data. This is because, even in a case where the primary reference data is included in the reference range, it can be assumed that an operation state of the refrigeration cycle device 40 is different due to a small difference.

Specific secondary reference data will be described. As shown in FIG. 6, the determination unit 56 determines that the temperature of a refrigerant discharged from the compressor 102 is not within a reference range in a case where the temperature is equal to or more than a certain temperature. This is because, in a case where the temperature of the refrigerant discharged from the compressor 102 is equal to or more than the certain temperature, there is a concern that the refrigerant may be insufficient due to a leakage of the refrigerant caused by a damage of the pipe 301 due to a disaster, and the refrigeration cycle device 40 is considered to have a failure. In addition, the temperature that is an upper limit of the reference range of the temperature of the refrigerant discharged from the compressor 102 is set to be higher in a case where a voltage value of the motor in the outdoor air blowing device 105 is large than in a case where the voltage value of the motor in the outdoor air blowing device 105 is small. This is because, in a case where the voltage value of the motor in the outdoor air blowing device 105 is large, it is considered that a compression ratio in a compression chamber of the compressor 102 tends to be relatively high.

In addition, as shown in FIG. 6, the determination unit 56 determines that the temperature of a refrigerant in the pipe 301 between the decompression device 103 and the outdoor heat exchanger 104 is not within a reference range in a case where the temperature is equal to or more than a certain temperature. This is because, in a case where the temperature of the pipe 301 between the decompression device 103 and the outdoor heat exchanger 104 is equal to or more than the certain temperature, it is considered that the decompression device 103 has a failure due to a disaster and the refrigeration cycle device 40 does not operate normally. In addition, the temperature that is an upper limit of the reference range of the temperature of the refrigerant in the pipe 301 between the decompression device 103 and the outdoor heat exchanger 104 is set to be higher in a case where the voltage value of the motor in the outdoor air blowing device 105 is large than in a case where the voltage value of the outdoor air blowing device 105 is small. This is because, in a case where the voltage value of the motor in the outdoor air blowing device 105 is large, it is considered that the temperature of the refrigerant in the refrigeration cycle device 40 tends to be relatively high.

In addition, as shown in FIG. 6, the determination unit 56 determines that a voltage value of the motor in the indoor air blowing device 202 is not within a reference range in a case where the voltage value is less than a predetermined first temperature or in a case where the voltage value is more than a predetermined second temperature. This is because, in a case where the voltage value of the motor in the indoor air blowing device 202 is a value that is significantly more than a rated voltage value, it is considered that the indoor air blowing device 202 may have a failure due to a disaster. In addition, the value of the voltage value of the motor in the indoor air blowing device 202 in the reference range is set to be higher in a case where the voltage value of the outdoor air blowing device 105 is large than in a case where the voltage value of the motor in the outdoor air blowing device 105 is small. This is because, in a case where the voltage value of the motor in the outdoor air blowing device 105 is large, it is considered that the voltage value of the motor in the indoor air blowing device 202 also tends to be high.

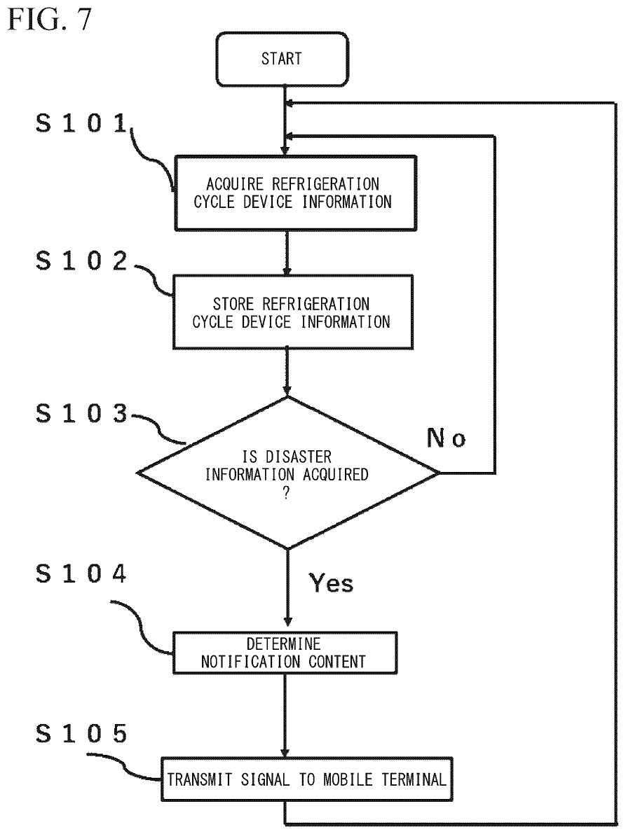

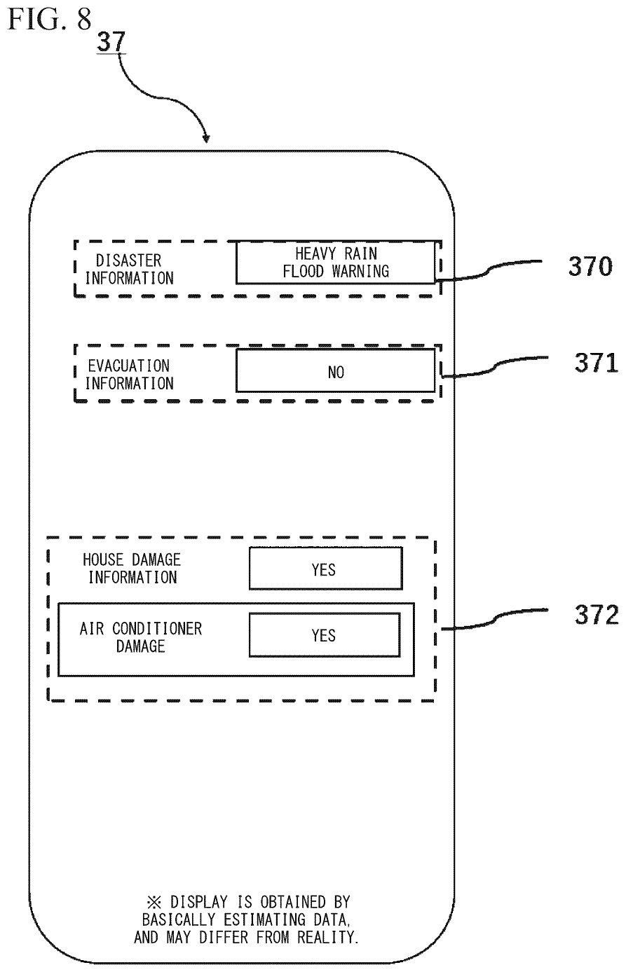

FIG. 7 is a flowchart showing a process performed by the damage information detection device 50 included in a damage information detection system according to Embodiment 1. The process performed by the damage information detection device 50 will be described with reference to FIG. 7. The damage information detection device 50 starts the process at the same time as start of the damage information detection system 100 after a user pre-registers an installation location of the refrigeration cycle device 40.

In step S101, in a case where the damage information detection device 50 starts a process, the process is performed. In step S101, the damage information detection device-side transmission and reception unit 55 acquires refrigeration cycle device information. In Embodiment 1, the refrigeration cycle device information is acquired by the damage information detection device-side transmission and reception unit 55 for a predetermined time, for example, at an interval of 1 hour. In step S101, in a case where the refrigeration cycle device information is acquired, the process is ended.

In step S102, a process is performed after the process in step S101. In step S102, the damage information detection device-side storage unit 57 stores the refrigeration cycle device information acquired in step S101. In step S102, in a case where the refrigeration cycle device information is stored, the process is ended.

In step S103, a process is performed after the process in step S102. In step S103, the determination unit 56 determines whether disaster information is acquired from the server-side transmission and reception unit 25. In step S103, in a case where the determination unit 56 determines whether the condition is satisfied, the process is ended.

In a case where it is determined in step S103 that the disaster information is not acquired (No in step S103), the damage information detection device-side transmission and reception unit 55 executes step S101.

In step S104, in a case where it is determined in step S103 that the disaster information is acquired (Yes in step S103), the process is performed. In step S104, the determination unit 56 determines a notification content for a user. The determination of the notification content is performed by estimating damage information of the refrigeration cycle device 40 and the inside of the building 200 from the primary determination and the secondary determination described above. In step S104, in a case where the notification content is determined, the process is ended.

In step S105, a process is performed after the process in step S104. In step S104, the damage information detection device-side transmission and reception unit 55 transmits a signal for providing notification of the notification content determined in step S104, to a mobile terminal. In step S105, in a case where the signal is transmitted to the mobile terminal, the process is ended.

After the process in step S105, the damage information detection device-side transmission and reception unit 55 executes step S101.

FIG. 8 is a diagram showing an example of a screen on which damage information is notified to the notification unit 37 of the mobile terminal 30 included in the damage information detection system 100 according to Embodiment 1. A method of notifying a user of the damage information in the damage information detection system 100 will be described with reference to FIG. 8.

As shown in FIG. 8, in a case of notifying the user of the damage information, the notification unit 37 of the mobile terminal 30 includes a disaster information display unit 370, an evacuation information display unit 371, and a house damage information display unit 372. The disaster information display unit 370 indicates the type of disaster information received from the server-side transmission and reception unit 25. In a case where the disaster information is not notified, nothing is displayed on the disaster information display unit. The evacuation information display unit 371 displays the presence or absence of evacuation information in the building 200. The evacuation information display unit 371 displays the evacuation information as “YES” in a case where the evacuation information is present, and displays the evacuation information as “NO” in a case where the evacuation information is absent. The house damage information display unit 372 displays the presence or absence of a damage to the building 200. The house damage information display unit 372 displays a notification content determined by the determination unit 56. Specifically, the house damage information display unit 372 displays house damage information and an air conditioner damage as “YES” in a case where the determination unit 56 determines that the damage information is present, and displays the house damage information and the air conditioner damage as “NO” in a case where the determination unit 56 determines that the damage information is absent. That is, in a case where it is estimated that the refrigeration cycle device 40 is damaged, it is also estimated that the house damage information is present. This is because it is considered that the house is also damaged in a case where the refrigeration cycle device 40 is damaged. In addition, in a case where the determination unit 56 determines that the determination is unavailable, the house damage information display unit 372 displays the house damage information and the air conditioner damage as “undeterminable”.

As described above, an information processing system (corresponding to the damage information detection system 100) according to Embodiment 1 includes a refrigeration cycle device information acquisition unit (corresponding to the outdoor information acquisition unit 450 and the indoor information acquisition unit 460) that acquires refrigeration cycle device information acquired from the refrigeration cycle device 40 having the indoor unit 400 fixed inside a building and the outdoor unit 410 fixed outside the building, a storage unit (corresponding to the damage information detection device-side storage unit 57) that stores a reference range of data for each refrigeration cycle device information, a reception unit (corresponding to the server-side transmission and reception unit 25) that receives disaster information for notifying that a disaster is occurring at a location at which the refrigeration cycle device 40 is installed, the determination unit 56 that determines, in a case where the disaster information is received by the reception unit, whether the acquired refrigeration cycle device information is included in the reference range stored in the storage unit to estimate damage information of the refrigeration cycle device 40 and the inside of the building 200, and determines a notification content, and the notification unit 37 that notifies the notification content determined by the determination unit 56. With this configuration, the information processing system according to Embodiment 1 achieves an effect of improving accuracy of the damage information of the refrigeration cycle device and the inside of the building, which is estimated information.

In addition, an information processing device (corresponding to the damage information detection device 50) according to Embodiment 1 includes a reception unit (corresponding to the damage information detection device-side transmission and reception unit 55) that receives disaster information for notifying that a disaster is occurring at a location at which the refrigeration cycle device 40 having the indoor unit 400 fixed inside the building 200 and the outdoor unit 410 fixed outside the building 200 is installed, and refrigeration cycle device information acquired from the refrigeration cycle device, a storage unit (corresponding to the damage information detection device-side storage unit 57) that stores a value indicating a reference range of data for each refrigeration cycle device information, the determination unit 56 that determines whether the disaster information and the refrigeration cycle device information received by the reception unit are included in the reference range stored in the storage unit to estimate damage information of the refrigeration cycle device 40 and the inside of the building 200, and determines a notification content, and a transmission unit (corresponding to the damage information detection device-side transmission and reception unit 55) that transmits a signal for providing notification of the notification content determined by the determination unit 56, to the notification unit 37 that provides notification of the notification content. With this configuration, the information processing device according to Embodiment 1 achieves an effect of improving accuracy of the damage information of the refrigeration cycle device and the inside of the building, which is estimated information.

In addition, an information processing method according to Embodiment 1 includes a first step in which the determination unit 56 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 37 provides notification of the notification content determined in the first step. With this configuration, the information processing method according to Embodiment 1 achieves an effect of improving accuracy of the damage information of the refrigeration cycle device and the inside of the building, which is estimated information.

In addition, a program according to Embodiment 1 causes a computer to execute a first step in which the determination unit 56 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 37 provides notification of the notification content determined in the first step. With this configuration, the program according to Embodiment 1 achieves an effect of improving accuracy of the damage information of the refrigeration cycle device and the inside of the building, which is estimated information.

In addition, as an additional configuration, in the information processing system (corresponding to the damage information detection system 100) according to Embodiment 1, the refrigeration cycle device information includes outdoor information indicating information on a space in which the outdoor unit 410 is installed. With this additional configuration, the information processing system according to Embodiment 1 achieves an effect capable of estimating a situation of the outdoor unit 410 with high accuracy.

In addition, as the additional configuration, in the information processing system according to Embodiment 1 (corresponding to the damage information detection system 100), the outdoor unit 410 includes the compressor 102, the outdoor heat exchanger 104, the outdoor air blowing device 105 that blows an outdoor air to the outdoor heat exchanger 104, and the decompression device 103, and the outdoor information includes at least one information of the temperature of a refrigerant discharged from the compressor 102, a voltage value of a motor in the outdoor air blowing device 105, or the temperature of a refrigerant in a pipe connecting the decompression device 103 and the outdoor heat exchanger 104. With this additional configuration, the information processing system according to Embodiment 1 achieves an effect capable of estimating the damage information of the refrigeration cycle device and the inside of the building with higher accuracy.

In addition, as the additional configuration, in the information processing system (corresponding to the damage information detection system 100) according to Embodiment 1, the determination unit 56 determines whether each of the acquired refrigeration cycle device information is included in the reference range stored in the storage unit (corresponding to the damage information detection device-side storage unit 57) and determines that the refrigeration cycle device 40 is damaged in a case where there is refrigeration cycle device information that is not included in the reference range, and the notification unit 37 notifies that the refrigeration cycle device 40 is damaged. With this additional configuration, the information processing system according to Embodiment 1 achieves an effect capable of estimating the damage information of the refrigeration cycle device and the inside of the building with higher accuracy.

In addition, as the additional configuration, in the information processing system (corresponding to the damage information detection system 100) according to Embodiment 1, the refrigeration cycle device information includes two or more types of information, one type of information of the refrigeration cycle device information is set as primary reference data and information other than the primary reference data is set as secondary reference data, and in a case where the primary reference data is included in the reference range, the determination unit 56 determines whether the secondary reference data is included in each reference range. With this additional configuration, the information processing system according to Embodiment 1 achieves an effect capable of estimating the damage information of the refrigeration cycle device and the inside of the building with higher accuracy.

In addition, as an additional configuration, in the information processing device (corresponding to the damage information detection device 50) according to Embodiment 1, the determination unit 56 determines whether each of the acquired refrigeration cycle device information is included in a reference range stored in the storage unit (corresponding to the damage information detection device-side storage unit 57) and determines that the refrigeration cycle device 40 is damaged in a case where there is refrigeration cycle device information that is not included in the reference range, and the transmission unit (corresponding to the damage information detection device-side transmission and reception unit 55) transmits damage information. With this additional configuration, the information processing device according to Embodiment 1 achieves an effect capable of estimating the damage information of the refrigeration cycle device and the inside of the building with higher accuracy.

In addition, as an additional configuration, in the information processing method and the program according to Embodiment 1, the refrigeration cycle device information includes outdoor information indicating information on a space in which the outdoor unit 410 is installed. With this additional configuration, the information processing method and the program according to Embodiment 1 achieve an effect capable of estimating a situation of the outdoor unit 410 with high accuracy.

In addition, as the additional configuration, in the information processing method and the program according to Embodiment 1, in the first step, the determination unit 56 determines whether each of the acquired refrigeration cycle device information is included in a reference range stored in the storage unit (corresponding to the damage information detection device-side storage unit 57), and determines that the refrigeration cycle device 40 is damaged in a case where there is refrigeration cycle device information that is not included in the reference range, and in the second step, the notification unit 37 notifies that the refrigeration cycle device 40 is damaged. With this additional configuration, the information processing method and the program according to Embodiment 1 achieve an effect capable of estimating the damage information of the refrigeration cycle device and the inside of the building with higher accuracy.

In addition, as the additional configuration, in the information processing method and the program according to Embodiment 1, the refrigeration cycle device information includes two or more types of information, one type of information of the refrigeration cycle device information is set as primary reference data and information other than the primary reference data is set as secondary reference data, and in the first step, in a case where the primary reference data is included in the reference range, the determination unit 56 determines whether the secondary reference data is included in each reference range. With this additional configuration, the information processing method and the program according to Embodiment 1 achieve an effect capable of estimating the damage information of the refrigeration cycle device and the inside of the building with higher accuracy.

In Embodiment 1, the mobile terminal has the notification unit, but the present disclosure is not limited thereto. For example, the notification unit may be provided in a terminal such as a PC. In addition, the notification unit may be provided in the damage information detection device.

In addition, Embodiment 1 has the configuration in which the operation device and the display device of the mobile terminal are integrated by a touch panel, but the present disclosure is not limited thereto. For example, the operation device and the display device may be separate bodies, such as the operation device being an operation button and the display device being a display.

In addition, Embodiment 1 has the configuration in which the voltage values of the motor in the outdoor air blowing device and the motor in the indoor air blowing device are acquired, but the present disclosure is not limited thereto. For example, a configuration may be adopted in which a current value or power of the motor in the outdoor air blowing device and the indoor air blowing device is acquired.

In addition, in Embodiment 1, the refrigeration cycle device information is the voltage value of the motor in the outdoor air blowing device, the temperature of the refrigerant discharged from the compressor, the temperature of the refrigerant in the pipe between the decompression device and the outdoor heat exchanger, and the voltage value of the motor in the indoor air blowing device, but the present disclosure is not limited thereto. The refrigeration cycle device information may be any two or more pieces of information acquired from the refrigeration cycle device. The refrigeration cycle device information is, for example, the temperature in a pipe of a refrigerant sucked into the compressor, a flow rate or a flow velocity of the refrigerant flowing through the pipe, an opening degree of the decompression device, a rotation speed of the compressor, or a voltage value added to the compressor.

In addition, in Embodiment 1, the primary reference data of the refrigeration cycle device information is the voltage value of the motor in the outdoor air blowing device, but the present disclosure is not limited thereto. The primary reference data may be one or more pieces of information acquired from the refrigeration cycle device.

In addition, Embodiment 1 has the configuration in which the reference of the secondary reference data is changed by one piece of primary reference data, but the present disclosure is not limited thereto. For example, the reference of the secondary reference data may be determined in consideration of control information of a four-way valve, in addition to the primary reference data. This is because it is considered that an operation state of the refrigeration cycle device is changed by the control information of the four-way valve.

In addition, in Embodiment 1, the refrigeration cycle device has the four-way valve and is configured to be capable of switching between the cooling operation and the heating operation, but the present disclosure is not limited thereto. The refrigeration cycle device may be configured to perform only the cooling operation or the heating operation without the four-way valve.

In addition, Embodiment 1 has the configuration in which the outdoor unit control unit is provided outdoors and the indoor unit control unit is provided indoors, but the present disclosure is not limited thereto. For example, a configuration may be provided in which the outdoor unit control unit and the indoor unit control unit are provided outdoors. In addition, the outdoor unit control unit and the indoor unit control unit may be configured with the same device.

In addition, in Embodiment 1, the acquired refrigeration cycle device information includes both the indoor information and the outdoor information, but the present disclosure is not limited thereto. The acquired refrigeration cycle device information may be only the indoor information, or may be only the outdoor information.

In addition, Embodiment 1 has the configuration in which the server acquires the damage information, but the present disclosure is not limited thereto. A configuration may be provided in which the damage information detection device acquires the damage information.

In addition, in Embodiment 1, the evacuation information display unit of the notification unit displays only the presence or absence of the evacuation information, but the present disclosure is not limited thereto. For example, a route from the building to the nearest evacuation location may be displayed.

In addition, in Embodiment 1, the house damage information display unit of the notification unit displays only the presence or absence of the damage information, but the present disclosure is not limited thereto. For example, a configuration may be adopted in which refrigeration cycle device information acquired from the refrigeration cycle device indicates an abnormality is displayed.

In addition, Embodiment 1 has the configuration in which the same refrigeration cycle device information is always acquired regardless of an occurring disaster, but the present disclosure is not limited thereto. The refrigeration cycle device information to be acquired may be changed depending on the occurring disaster.

In addition, Embodiment 1 has the configuration in which regarding the damage information detection device-side transmission and reception unit, the server-side transmission and reception unit, and the terminal-side transmission and reception unit, the transmission units and the reception units are integrated, but the present disclosure is not limited thereto. The transmission unit and the reception unit may be configured to be independent separately.

### Modification Example of Embodiment 1

Next, a damage information detection system 500 in Embodiment 1 will be described. As compared with the damage information detection system 100 according to Embodiment 1, in the damage information detection system 500 according to a modification example of Embodiment 1, a process performed by the damage information detection device 60 is different. Since a configuration of the damage information detection system 500, which is obtained by excluding the treatment performed by the damage information detection device 60 has the same manner as the configuration of the damage information detection system 100 according to Embodiment 1, the description thereof will be omitted.

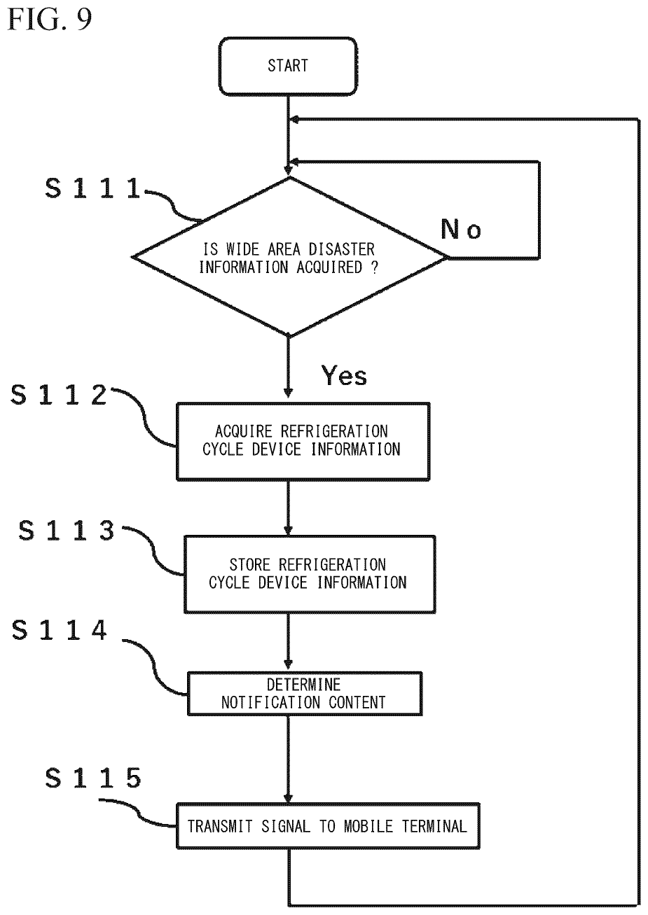

FIG. 9 is a flowchart showing a process performed by the damage information detection device 60 included in the damage information detection system 500 according to the modification example of Embodiment 1. The process performed by the damage information detection device 60 will be described with reference to FIG. 9. The damage information detection device 60 starts the process at the same time as start of the damage information detection system 500 after a pre-registration of an installation location of the refrigeration cycle device 40 by a user.

In step S111, in a case where the damage information detection device 60 starts a process, the process is performed. In step S111, the determination unit 66 determines whether disaster information is acquired from the server-side transmission and reception unit 25 for a predetermined time, for example, at an interval of 1 hour. In step S111, in a case where the determination unit 66 determines that a condition is satisfied, the process is ended.

In a case where it is determined in step S111 that the disaster information is not acquired (No in step S111), the determination unit 66 executes step S111.

In step S112, in a case where it is determined in step S111 that the disaster information is acquired (Yes in step S111), the process is performed. In step S112, the damage information detection device-side transmission and reception unit 55 acquires refrigeration cycle device information. In step S112, in a case where the refrigeration cycle device information is acquired, the process is ended.

In step S113, a process is performed after the process in step S112. In step S113, the damage information detection device-side storage unit 57 stores the refrigeration cycle device information acquired in step S112. In step S113, in a case where the refrigeration cycle device information is stored, the process is ended.

In step S114, a process is performed after the process in step S113. In step S114, the determination unit 66 determines a notification content for a user. The determination on the notification content is performed by estimating damage information of the refrigeration cycle device 40 and the inside of a building from the primary determination and the secondary determination described above. In step S114, in a case where the notification content is determined, the process is ended.

In step S115, a process is performed after the process in step S114. In step S115, the damage information detection device-side transmission and reception unit 55 transmits a signal for providing notification of the notification content determined in step S114, to a mobile terminal. In step S115, in a case where the signal is transmitted to the mobile terminal, the process is ended.

After the process in step S115, the determination unit 66 executes step S111.

In the modification example of Embodiment 1, the refrigeration cycle device information is acquired only in a case where the determination unit determines that the disaster information is acquired from the server-side transmission and reception unit (Yes in step S111). With this configuration, the use amount of the memory 62 of the damage information detection device 60 can be reduced.

### Embodiment 2

A damage information detection system 600 according to Embodiment 2 will be described. As compared with Embodiment 1, in the damage information detection system 600 according to Embodiment 2, a hardware configuration of the damage information detection system 600, a process performed by the damage information detection device 70, and a notification content notified from the notification unit 97 of the mobile terminal 90 are different. Since a configuration of the damage information detection system 600, which is obtained by excluding the hardware configuration, the process performed by the damage information detection device 70, and the notification content notified from the notification unit 97 has the same manner as the configuration of Embodiment 1, the description thereof will be omitted.

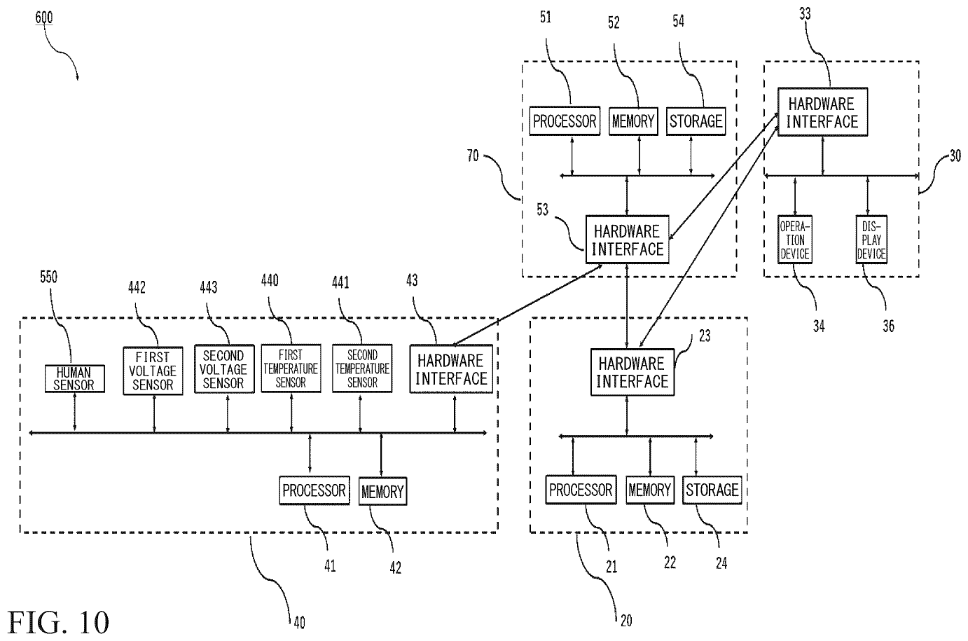

FIG. 10 is a block diagram showing a hardware configuration of the damage information detection system 600 according to Embodiment 2. The hardware configuration of the damage information detection system 600 will be described with reference to FIG. 10.

As compared with the hardware configuration of the damage information detection system 100, the hardware configuration of the damage information detection system 600 is different in that a human sensor 550 is provided. Since a hardware configuration obtained by excluding the human sensor 550 has the same manner as the hardware configuration of the damage information detection system 100, the description thereof will be omitted.

The human sensor 550 is installed in the indoor unit 400 of the refrigeration cycle device 40, and detects the presence or absence of a person around the indoor unit 400 in the building 200. The human sensor 550 is, for example, an infrared sensor, and can detect the presence or absence of a person within 8 meters from an installation location. That is, refrigeration cycle device information acquired by the human sensor 550 is indoor information. Therefore, the human sensor 550 constitutes part of the indoor information acquisition unit 460.

The determination unit 76 of the damage information detection device 70 determines a notification content notified from the notification unit 97. In a case where disaster information is received from the server 20, the determination unit 76 determines whether the refrigeration cycle device information is data in a reference range stored in the damage information detection device-side storage unit 57. The determination unit 76 estimates damage information of the refrigeration cycle device 40 and a space in which the refrigeration cycle device 40 is installed, that is, a location of the building 200, based on the determination, and determines the notification content. More specifically, the determination unit 76 uses one refrigeration cycle device information of the received refrigeration cycle device information as primary reference data, and determines that the damage information of the refrigeration cycle device 40 is undeterminable in a case where it is determined that the primary reference data is not included in the reference range. In addition, in a case where it is determined that the primary reference data is included in the reference range, the determination unit 76 determines whether the refrigeration cycle device information other than the primary reference data is included in a reference range determined by a value of the primary reference data. In addition, in a case where evacuation information is acquired from a server together with the disaster information, the determination unit 76 determines whether a person is present around the indoor unit 400 of the refrigeration cycle device 40. The evacuation information is, for example, an evacuation instruction issued by a government. In a case where it is determined that a person is present around the indoor unit 400, the determination unit 76 generates the evacuation information. This is because it is necessary to notify that it is necessary to evacuate to a safe location in such a situation. The evacuation information is, for example, a message or an alert sound output to the notification unit 97.

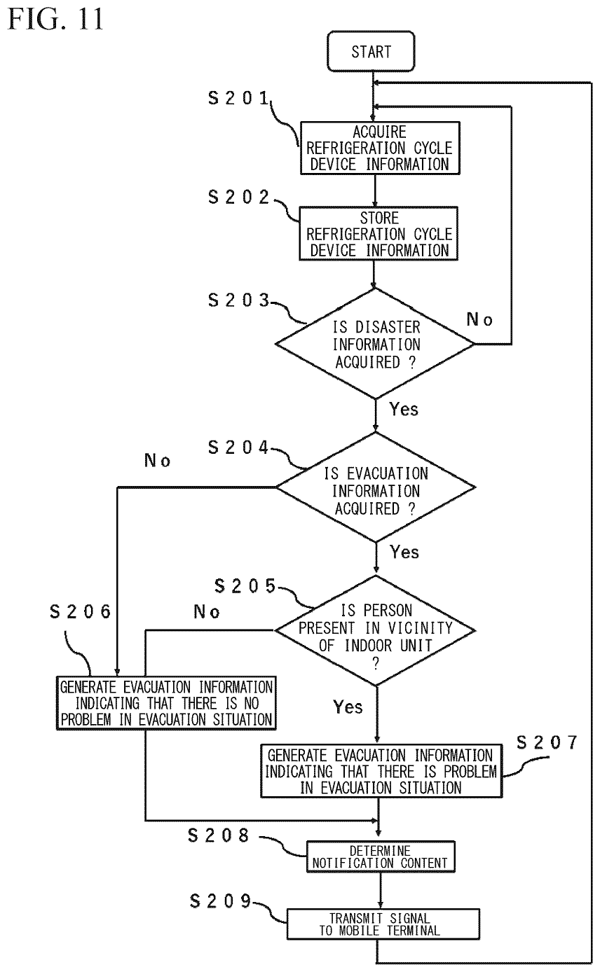

FIG. 11 is a flowchart showing a process performed by a damage information detection device included in the damage information detection system 600 according to Embodiment 2. A process performed by the damage information detection device 70 will be described with reference to FIG. 11. Since steps S201 to S203 are the same as the processes in S101 to S103 in Embodiment 1, the description thereof will be omitted.

In step S204, in a case where it is determined in step S203 that disaster information is acquired (Yes in step S103), the process is performed. In step S204, the determination unit 76 determines whether evacuation information is acquired from the server-side transmission and reception unit 25. In step S204, in a case where the determination unit 76 determines that a condition is satisfied, the process is ended.

In step S205, in a case where it is determined in step S204 that the evacuation information is acquired (Yes in step S204), the process is performed. In step S205, the determination unit 76 determines whether a person is present in the vicinity of the indoor unit 400 in the building 200. Specifically, the determination unit 76 determines whether the human sensor 550 detects a person. In step S205, in a case where the determination unit 76 determines that a condition is satisfied, the process is ended.

In step S206, in a case where it is determined in step S204 that the evacuation information is not acquired (No in step S204) or in a case where it is determined in step S205 that a person is not present in the vicinity of the indoor unit 400 (No in step S205), the process is performed. In step S206, the determination unit 76 generates a signal for notifying the evacuation information indicating that there is no problem in an evacuation situation. That is, in a case where the evacuation information is not acquired or in a case where the evacuation information is acquired but it is determined that there are no person in the vicinity of the indoor unit 400, the determination unit 76 determines that there is no problem with the evacuation information. In step S206, in a case where the evacuation information is generated, the process is ended.

In step S207, in a case where it is determined in step S205 that a person is present in the vicinity of the indoor unit 400 (Yes in step S205), the process is performed. In step S207, the determination unit 76 generates a signal for providing notification of the evacuation information indicating that there is a problem in the evacuation situation. That is, in a case where the evacuation information is acquired and it is determined that a person is present in the vicinity of the indoor unit 400, the determination unit 76 determines that there is a problem with the evacuation information. In step S207, in a case where the evacuation information is generated, the process is ended.

In step S208, a process is performed after the process in step S206 or after the process in step S207. In step S208, the determination unit 76 determines a notification content for a user. The determination of the notification content is performed by estimating damage information of the refrigeration cycle device 40 and the inside of the building 200 from the primary determination and the secondary determination described above. In step S208, in a case where the notification content is determined, the process is ended.

In step S209, a process is performed after the process in step S208. In step S209, the damage information detection device-side transmission and reception unit 55 transmits a signal for providing notification of the notification content determined in step S206 or step S207 and step S208, to a mobile terminal. In step S208, in a case where the signal is transmitted to the mobile terminal 90, the process is ended.

After the process in step S209, the damage information detection device-side transmission and reception unit 55 executes step S201.

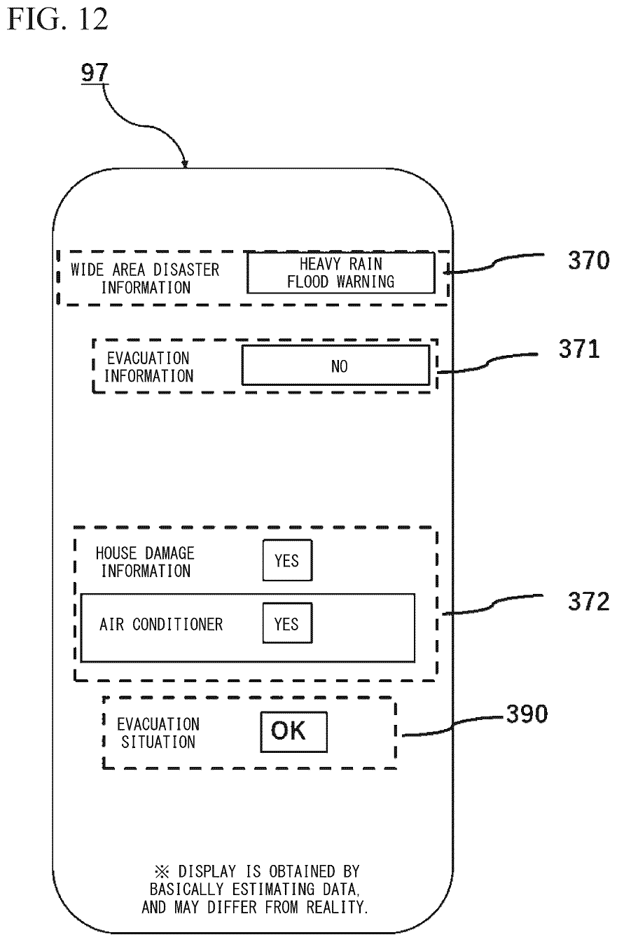

FIG. 12 is a diagram showing an example of a screen on which damage information is notified to the notification unit 97 of the mobile terminal 90 included in the damage information detection system 600 according to Embodiment 2. A method of notifying a user of the damage information in the damage information detection system 600 will be described with reference to FIG. 12.

As shown in FIG. 12, in a case where the damage information is notified to the user in Embodiment 2, the notification unit 97 of the mobile terminal has an evacuation situation display unit 390. The evacuation situation display unit 390 displays evacuation information determined by the determination unit 76. Specifically, when disaster information is notified, the evacuation situation display unit 390 displays “NG” in a case where the determination unit 76 determines that refrigeration cycle device information is not data included in a reference range and determines that a person is present in the vicinity of the indoor unit 400, and displays “OK” in the other cases. The disaster information display unit 370, the evacuation information display unit 371, and the house damage information display unit 372 are the same as those in Embodiment 1, and thus the description thereof will be omitted.

The damage information detection system 600 according to Embodiment 2 determines the presence or absence of a person around the indoor unit 400, and generates evacuation information indicating that there is a problem in an evacuation situation in a case where it is determined that there is a person. With this configuration, the damage information detection system 600 according to Embodiment 2 can generate the evacuation information due to a disaster without imposing a burden on the user.

As described above, an information processing system (corresponding to the damage information detection system 600) according to Embodiment 2 includes a refrigeration cycle device information acquisition unit (corresponding to the outdoor information acquisition unit 450 and the indoor information acquisition unit 460) that acquires refrigeration cycle device information acquired from the refrigeration cycle device 40 having the indoor unit 400 fixed inside a building and the outdoor unit 410 fixed outside the building, a storage unit (corresponding to the damage information detection device-side storage unit 57) that stores a reference range of data for each refrigeration cycle device information, a reception unit (corresponding to the server-side transmission and reception unit 25) that receives disaster information for notifying that a disaster is occurring at a location at which the refrigeration cycle device 40 is installed, the determination unit 76 that determines, in a case where the disaster information is received by the reception unit, whether the acquired refrigeration cycle device information is data included in the reference range stored in the storage unit to estimate damage information of the refrigeration cycle device 40 and the inside of the building 200, and determines a notification content, and the notification unit 97 that notifies the notification content determined by the determination unit 76. With this configuration, the information processing system according to Embodiment 2 achieves the same effect as the effect described in Embodiment 1.

In addition, an information processing device (corresponding to the damage information detection device 70) according to Embodiment 2 includes a reception unit (corresponding to the damage information detection device-side transmission and reception unit 55) that receives disaster information for notifying that a disaster is occurring at a location at which the refrigeration cycle device 40 having the indoor unit 400 fixed inside the building 200 and the outdoor unit 410 fixed outside the building 200 is installed, and refrigeration cycle device information acquired from the refrigeration cycle device, a storage unit (corresponding to the damage information detection device-side storage unit 57) that stores a value indicating a reference range of data for each refrigeration cycle device information, the determination unit 76 that determines whether the disaster information and the refrigeration cycle device information received by the reception unit are data included in the reference range stored in the storage unit to estimate damage information of the refrigeration cycle device 40 and the inside of the building 200, and determines a notification content, and a transmission unit (corresponding to the damage information detection device-side transmission and reception unit 55) that transmits a signal for providing notification of the notification content determined by the determination unit 76, to the notification unit 97 that provides notification of the notification content. With this configuration, the information processing device according to Embodiment 2 achieves the same effect as the effect described in Embodiment 1.

In addition, an information processing method according to Embodiment 2 includes a first step in which the determination unit 76 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 97 provides notification of the notification content determined in the first step. With this configuration, the information processing device according to Embodiment 2 achieves the same effect as the effect described in Embodiment 1.

In addition, a program according to Embodiment 2 causes a computer to execute a first step in which the determination unit 76 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 97 provides notification of the notification content determined in the first step. With this configuration, the program according to Embodiment 2 achieves the same effect as the effect described in Embodiment 1.

In addition, as an additional configuration, in the information processing system (corresponding to the damage information detection system 600) according to Embodiment 2, the refrigeration cycle device information includes in-person determination information for determining whether a person is present inside the building 200, and in a case where the reception unit (corresponding to the server-side transmission and reception unit 25) receives evacuation information at a location at which the refrigeration cycle device 40 is installed and the in-person determination information is information indicating that a person is present inside the building 200, the notification unit 97 provides notification of the evacuation information for notifying that a person is present inside. With this additional configuration, the information processing system according to Embodiment 2 achieves an effect capable of generating the evacuation information due to a disaster without imposing a burden on a user.

In addition, as an additional configuration, in the information processing method and the program according to Embodiment 2, the refrigeration cycle device information includes in-person determination information for determining whether a person is present inside the building 200, and in a case where the reception unit (corresponding to the server-side transmission and reception unit 25) receives evacuation information at a location at which the refrigeration cycle device 40 is installed and the in-person determination information is information indicating that a person is present inside the building 200, the notification unit 97 provides notification of the evacuation information for notifying that a person is present inside. With this additional configuration, the information processing method and the program according to Embodiment 2 achieve an effect capable of generating the evacuation information due to a disaster without imposing a burden on a user.

In Embodiment 2, the presence or absence of a person in the vicinity of the indoor unit is detected by the human sensor, but the present disclosure is not limited thereto. A configuration may be provided in which the indoor unit of the refrigeration cycle device can detect the presence or absence of a person in the building in which the indoor unit is installed. For example, the sensor may be a thermal image sensor, an ultrasonic sensor, or an optical sensor. A configuration in which a person's heart rate is measured by a non-contact millimeter-wave radar may be adopted, or a configuration in which accurate in-person information is obtained by tracing a person's movement in time series may be adopted.

In addition, in Embodiment 2, the human sensor is a sensor provided in the indoor unit, but the present disclosure is not limited thereto. For example, the hardware interface may be a hardware interface that acquires a signal from a device paired with the air conditioner.

In addition, in Embodiment 2, the notification unit of the mobile terminal issues an alert sound, but the present disclosure is not limited thereto. For example, a configuration in which the indoor unit emits an alert sound may be adopted. With this configuration, an effect capable of appropriately providing the evacuation information to the person who needs to evacuate is achieved.

### Embodiment 3

A damage information detection system 700 according to Embodiment 3 will be described. As compared with Embodiment 1, in the damage information detection system 700 according to Embodiment 3, a content of a pre-registration performed by a user before start of use of the system, a process performed by the damage information detection device 80, and a notification content notified by the notification unit 107 are different. Since a configuration obtained by excluding the content of the pre-registration performed by the user before the start of the use of the system, the process performed by the damage information detection device 80, and the notification content notified by the notification unit 107 has the same manner as the configuration of Embodiment 1, the description thereof will be omitted.

In Embodiment 3, the user performs the pre-registration by using the mobile terminal 110 before the start of the use of the system. In the pre-registration, in addition to the registration of information on the address of the building 200, the registration of each home appliance information installed inside the building 200 and the registration of an installation height in each home appliance are performed. Specifically, the registration of each home appliance information is performed by inputting a product name of the home appliance to the mobile terminal 110. The registered home appliances are, for example, a television, a landline telephone, and a washing machine. Specifically, the registration of an installation height in each home appliance is performed by inputting a height from a floor on which each home appliance is installed to the mobile terminal. Since the indoor unit 400 of the refrigeration cycle device 40 is generally provided on a ceiling or a wall near the ceiling, an installation height is not pre-registered. The pre-registered content is stored in the damage information detection device-side storage unit 67. The damage information detection device-side storage unit 67 stores each piece of home appliance information and an installation height of a home appliance in association with each other for the home appliance. In addition, the damage information detection device-side storage unit 67 stores product information, which is information on a product, for the indoor unit 400 of the refrigeration cycle device 40.

The determination unit 86 of the damage information detection device 80 determines a notification content of the notification by the notification unit 107. In a case where disaster information is received from the server 20, the determination unit 86 determines whether refrigeration cycle device information is data in a reference range stored in the damage information detection device-side storage unit 67. The determination unit 86 estimates damage information of the refrigeration cycle device 40 and damage information of the inside of the building 200, based on the determination, and determines a notification content. More specifically, the determination unit 86 uses one refrigeration cycle device information of the received refrigeration cycle device information as primary reference data, and determines that the damage information of the refrigeration cycle device 40 is undeterminable in a case where it is determined that the primary reference data is not included in the reference range. In addition, in a case where it is determined that the primary reference data is included in the reference range, the determination unit 86 determines whether the refrigeration cycle device information other than the primary reference data is included in a reference range determined by a value of the primary reference data.

In addition, in a case where inundation damage information is included in the damage information received from the server 20, the determination unit 86 compares the installation height of the registered home appliance with the inundation damage information to estimate an inundation of the home appliance and calculate the damage amount. Disaster information on a disaster that causes a damage of the inundation, such as a storm surge, heavy rain, a flood, or a tsunami includes inundation disaster information that is information on a height of the inundation. The inundation disaster information is information indicating an inundation height, and is, for example, inundation depth information or sea level information of an inundation area. More specifically, in a case where the inundation height included in the inundation damage information is more than an installation height of a certain home appliance, it is estimated that the home appliance is inundated. In addition, in a case where the installation height of the home appliance is more than the inundation height, it is estimated that the home appliance is not inundated. In addition, in a case where it is determined that the refrigeration cycle device 40 and one or more products of the home appliances are damaged, the determination unit 86 estimates that there is damage information on the inside of the building 200. The inundation damage amount is calculated from a price of the product that is pre-registered. With such a configuration, it is possible to quickly calculate the damage amount in a case where the home appliance is damaged due to the inundation. In addition, the indoor unit 400 is provided on the ceiling and has a low possibility of receiving the inundation damage. Therefore, only the damage amount is calculated, without comparing the installation height with the inundation height.

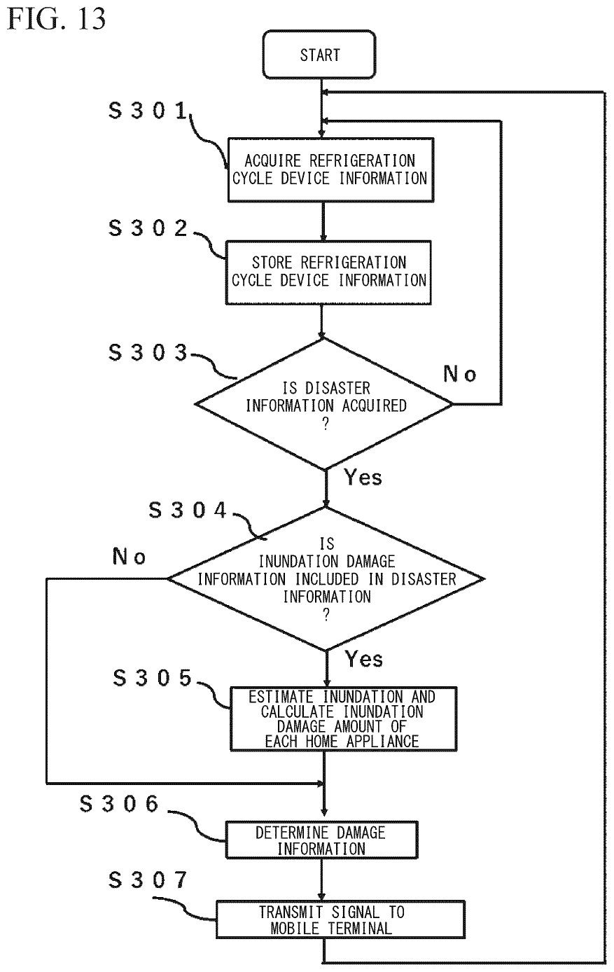

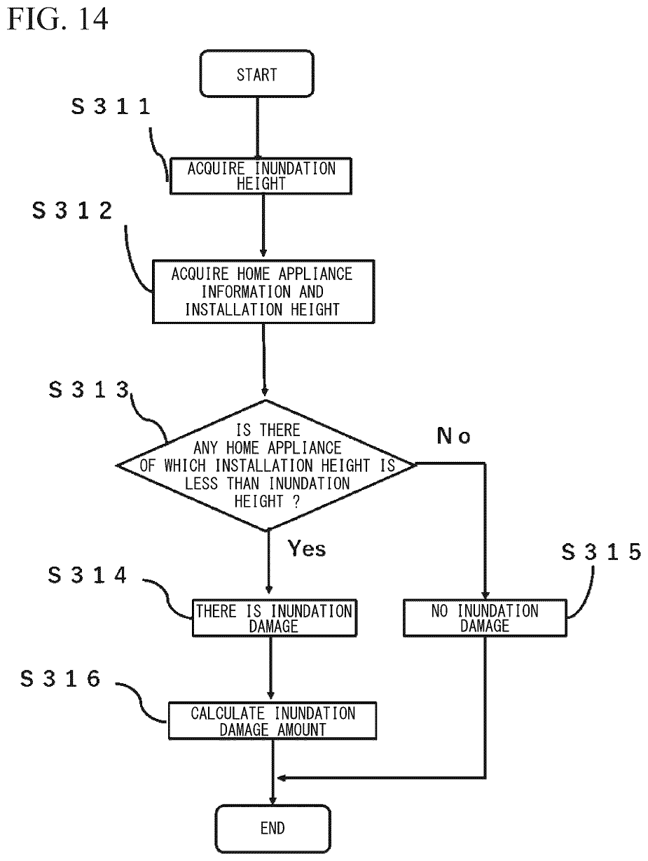

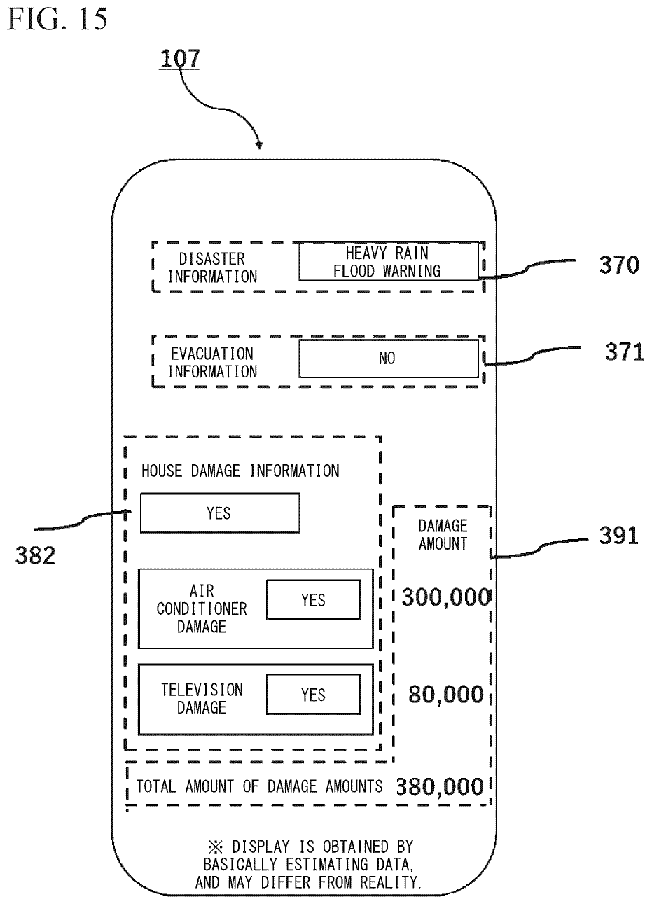

FIG. 13 is a flowchart showing a process performed by a damage information detection device included in the damage information detection system 700 according to Embodiment 3. FIG. 14 is a flowchart showing an inundation estimation process and an inundation damage amount calculation process of each home appliance according to Embodiment 3, and more specifically, is a flowchart in which step S305 in FIG. 13 is described in detail. A process performed by the damage information detection device 80 will be described with reference to FIGS. 13 and 14. Since processes in step S301 and step S302 are the same as the processes in step S101 and step S102 in Embodiment 1, the description thereof will be omitted.

In step S303, a process is performed after the process in step S302. In step S303, the determination unit 86 determines whether disaster information is acquired from the server-side transmission and reception unit 25. In step S303, in a case where the determination unit 86 determines that a condition is satisfied, the process is ended.

In a case where it is determined in step S303 that the disaster information is not acquired (No in step S303), the damage information detection device-side transmission and reception unit 55 executes step S301.

In step S304, in a case where it is determined in step S303 that the disaster information is acquired (Yes in step S303), the process is performed. In step S304, the determination unit 86 determines whether inundation damage information is included in the disaster information acquired in step S303. In step S304, in a case where the determination unit 86 determines that a condition is satisfied, the process is ended.

In step S305, in a case where it is determined in step S304 that inundation damage information is acquired (Yes in step S304), the process is performed. In step S305, an inundation estimation and an inundation damage amount calculation of each home appliance are performed. More specifically, in the process in step S305, processes in step S311 to step S316 are performed as shown in FIG. 14. The processes in step S311 to step S316 will be described.

In step S311, a process is performed after the process in step S304. In step S311, the damage information detection device-side transmission and reception unit 55 acquires an inundation height from the server-side transmission and reception unit 25. In step S311, in a case where the inundation height is acquired, the process is ended.

In step S312, a process is performed after the process in step S311. In step S312, the determination unit 86 acquires information in which home appliance information stored in the damage information detection device-side storage unit 67 and an installation height of the home appliance are associated with each other. In step S312, in a case where the home appliance information and the installation height are acquired, the process is ended.

In step S313, a process is performed after the process in step S312. In step S313, the determination unit 86 determines whether there is a case where the installation height of each home appliance acquired in step S312 is less than the inundation height. In step S313, in a case where the determination unit 86 determines that a condition is satisfied, the process is ended.

In step S314, a process is performed in a case where it is determined in step S313 that there is the home appliance of which the installation height is less than the inundation height (Yes in step S313). In step S314, the determination unit 86 estimates that the building 200 is receiving an inundation damage. In step S314, in a case where it is estimated that the inundation damage occurs, the process is ended.

In step S315, a process is performed in a case where it is determined in step S313 that there is no home appliance of which the installation height is less than the inundation height (No in step S315). In step S315, the determination unit 86 estimates that the building 200 is not receiving an inundation damage. In step S315, in a case where it is estimated that the inundation damage does not occur, the process is ended.

In step S316, a process is performed after the process in step S314. In step S316, the determination unit 86 calculates the inundation damage amount. More specifically, the determination unit 86 calculates the inundation damage amount by using the home appliance information of the home appliance of which the installation height is determined to be less than the inundation height in step S313. The home appliance information is acquired from the damage information detection device-side storage unit 67. The determination unit 86 acquires a price of the home appliance information, and calculates the inundation damage amount from the price of the product.

In a case where the process in step S315 or the process in step S316 is ended, the process in step S305 is ended.

In step S306, a process is performed after the process in step S305 or in a case where it is determined in step S304 that the inundation damage information is not acquired (No in step S304). In step S306, the determination unit 86 determines a notification content for a user. The determination of the notification content is performed by estimating the damage information of the refrigeration cycle device 40, the damage information of the home appliance in the inside of the building 200, and the damage information in the inside of the building 200 from the primary determination and the secondary determination described above. In addition to the damage estimation, the damage amount is also calculated in Embodiment 3. The estimation of the damage amount is performed by using the product information and the home appliance information of the indoor unit 400, which are pre-registered, in a case where it is estimated that the refrigeration cycle device 40 or the home appliance is damaged. The product information of the indoor unit 400 and the home appliance information are acquired from the damage information detection device-side storage unit 67. In step S306, in a case where the notification content is determined, the process is ended.

In step S307, a process is performed after the process in step S306. In step S307, the damage information detection device-side transmission and reception unit 55 transmits a signal for notifying the notification content determined in step S305 and step S306, to the mobile terminal 110. In step S307, in a case where the signal is transmitted to the mobile terminal 110, the process is ended.

After the process in step S307, the damage information detection device-side transmission and reception unit 55 executes step S301.

FIG. 14 is a diagram showing an example of a screen on which damage information is notified to the notification unit 107 of the mobile terminal 110 included in the damage information detection system 700 according to Embodiment 3. A method of notifying a user of the damage information in the damage information detection system 700 will be described with reference to FIG. 14.

As shown in FIG. 14, in a case of notifying the user of the damage information in Embodiment 3, a notification content of a house damage information display unit 382 of the notification unit 107 of the mobile terminal 110 is different as compared with Embodiment 1. In addition, the notification unit 107 includes a damage amount display unit 391.

The house damage information display unit 382 displays the damage information which is the notification content determined by the determination unit 86. Specifically, the house damage information display unit 382 displays an air conditioner damage as “YES” in a case where the refrigeration cycle device 40 is determined to be damaged, and displays the air conditioner damage as “NO” in a case where the refrigeration cycle device 40 is determined not to be damaged. In addition, in a case where the determination unit 86 determines that the determination is unavailable, the house damage information display unit 382 displays the air conditioner damage as “undeterminable”.

The house damage information display unit 382 displays not only the damage of the air conditioner but also a damage of another home appliance. Specifically, in a case where the determination unit 86 determines that the home appliance installed indoors in the building 200 is receiving an inundation damage, a damage is displayed as “YES”, and in a case where the determination unit 86 determines that the home appliance is not receiving the inundation damage, the damage is displayed as “NO”.

In addition, in a case where the damage is displayed as “YES” for one or more home appliances, it is estimated that there is residential damage information, and the residential damage information is displayed as “YES”. This is because it is considered that the house is damaged in a case where the refrigeration cycle device 40 is damaged or the home appliance installed inside the building 200 is receiving the inundation damage. In addition, in a case where it is determined that there is no damage information of the refrigeration cycle device 40 and there is no inundation damage for the home appliance, the house damage information display unit 382 estimates that there is no house damage information, and displays the house damage information as “NO”. In addition, in a case where the determination unit 86 determines that the damage of the refrigeration cycle device 40 is not determinable, the house damage information display unit 382 displays the house damage information and the air conditioner damage as “undeterminable”.

The damage amount display unit 391 displays the damage amount of the refrigeration cycle device 40 and the damage amount of the home appliance estimated to receive the inundation damage. The damage amount is an amount determined from home appliance information which is pre-registered. The damage amount display unit 391 displays the damage amount of each home appliance. In addition, the damage amount display unit 391 displays the total amount of damage amounts, together with the damage amount of each home appliance. Since the disaster information display unit 370 and the evacuation information display unit 371 have the same manner as the disaster information display unit 370 and the evacuation information display unit 371 in Embodiment 1, the description thereof will be omitted.

The damage information detection system 700 according to Embodiment 3 estimates the inundation damage of the home appliance by comparing an inundation height with an installation height of the home appliance. With this configuration, the damage information detection system 700 according to Embodiment 3 achieves an effect capable of quickly calculating the damage amount in a case where the inundation damage occurs.

As described above, an information processing system (corresponding to the damage information detection system 700) according to Embodiment 3 includes a refrigeration cycle device information acquisition unit (corresponding to the outdoor information acquisition unit 450 and the indoor information acquisition unit 460) that acquires refrigeration cycle device information acquired from the refrigeration cycle device 40 having the indoor unit 400 fixed inside a building and the outdoor unit 410 fixed outside the building, a storage unit (corresponding to the damage information detection device-side storage unit 57) that stores a reference range of data for each refrigeration cycle device information, a reception unit (corresponding to the server-side transmission and reception unit 25) that receives disaster information for notifying that a disaster is occurring at a location at which the refrigeration cycle device 40 is installed, the determination unit 86 that determines, in a case where the disaster information is received by the reception unit, whether the acquired refrigeration cycle device information is data included in the reference range stored in the storage unit to estimate damage information of the refrigeration cycle device 40 and the inside of the building 200, and determines a notification content, and the notification unit 107 that notifies the notification content determined by the determination unit 86. With this configuration, the information processing system according to Embodiment 3 achieves the same effect as the effect described in Embodiment 1.

In addition, an information processing device (corresponding to the damage information detection device 80) according to Embodiment 3 includes a reception unit (corresponding to the damage information detection device-side transmission and reception unit 55) that receives disaster information for notifying that a disaster is occurring at a location at which the refrigeration cycle device 40 having the indoor unit 400 fixed inside the building 200 and the outdoor unit 410 fixed outside the building 200 is installed, and refrigeration cycle device information acquired from the refrigeration cycle device, a storage unit (corresponding to the damage information detection device-side storage unit 57) that stores a value indicating a reference range of data for each refrigeration cycle device information, the determination unit 86 that determines whether the disaster information and the refrigeration cycle device information received by the reception unit are data included in the reference range stored in the storage unit to estimate damage information of the refrigeration cycle device 40 and the inside of the building 200, and determines a notification content, and a transmission unit (corresponding to the damage information detection device-side transmission and reception unit 55) that transmits a signal for providing notification of the notification content determined by the determination unit 86, to the notification unit 107 that provides notification of the notification content. With this configuration, the information processing device according to Embodiment 3 achieves the same effect as the effect described in Embodiment 1.

In addition, an information processing method according to Embodiment 3 includes a first step in which the determination unit 86 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 107 provides notification of the notification content determined in the first step. With this configuration, the information processing device according to Embodiment 3 achieves the same effect as the effect described in Embodiment 1.

In addition, a program according to Embodiment 3 causes a computer to execute a first step in which the determination unit 86 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 57) to estimate damage information of the refrigeration cycle device 40 and the inside of the building 200, and determines a notification content, and a second step in which the notification unit 107 provides notification of the notification content determined in the first step. With this configuration, the program according to Embodiment 3 achieves the same effect as the effect described in Embodiment 1.

In addition, as an additional configuration, in the information processing system (corresponding to the damage information detection system 700) according to Embodiment 3, the storage unit (corresponding to the damage information detection device-side storage unit 67) stores product information for specifying the refrigeration cycle device 40, and in a case where it is determined that the refrigeration cycle device 40 is damaged, the determination unit 86 determines the damage amount of the refrigeration cycle device 40 from the product information, and the notification unit 107 provides notification of the damage amount. With this additional configuration, the information processing system according to Embodiment 3 achieves an effect capable of quickly calculating the damage amount in a case where the refrigeration cycle device is damaged.

In addition, as the additional configuration, in the information processing system (corresponding to the damage information detection system 700) according to Embodiment 3, the storage unit (corresponding to the damage information detection device-side storage unit 67) stores home appliance information for specifying a home appliance that is installed inside the building 200 and an installation height of the home appliance associated with the home appliance information, the reception unit (corresponding to the server-side transmission and reception unit 25) acquires an inundation height in an area including the building 200 in a case where the disaster information includes inundation damage information, the determination unit 86 determines the damage amount of the home appliance from the home appliance information in which the installation height associated with the home appliance information stored in the storage unit is less than the inundation height, and the notification unit 107 provides notification of the damage amount. With this additional configuration, the information processing system according to Embodiment 3 achieves an effect capable of quickly calculating the damage amount in a case where the inundation damage occurs.

In addition, as an additional configuration, in the information processing device (corresponding to the damage information detection device 80) according to Embodiment 3, the storage unit (corresponding to the damage information detection device-side storage unit 67) stores product information for specifying the refrigeration cycle device 40, and in a case where it is determined that the refrigeration cycle device 40 is damaged, the determination unit 86 determines the damage amount of the refrigeration cycle device 40 from the product information, and the transmission unit (corresponding to the damage information detection device-side transmission and reception unit 55) transmits a signal including the damage amount to the notification unit. With this additional configuration, the information processing device according to Embodiment 3 achieves an effect capable of quickly calculating the damage amount in a case where the refrigeration cycle device is damaged.

In addition, as the additional configuration, in the information processing device (corresponding to the damage information detection device 80) according to Embodiment 3, the storage unit (corresponding to the damage information detection device-side storage unit 67) stores home appliance information for specifying a home appliance that is installed inside the building 200 and an installation height of the home appliance associated with the home appliance information, the reception unit (corresponding to the damage information detection device-side transmission and reception unit 55) acquires an inundation height in an area including the building 200 from an external server in a case where the disaster information includes inundation damage information, the determination unit 86 determines the damage amount of the home appliance from the home appliance information in which the installation height associated with the home appliance information stored in the storage unit is less than the inundation height, and the transmission unit (corresponding to the damage information detection device-side transmission and reception unit 55) transmits a signal including the damage amount to the notification unit. With this additional configuration, the information processing system according to Embodiment 3 achieves an effect capable of quickly calculating the damage amount in a case where the inundation damage occurs.

In addition, as an additional configuration, in the information processing method and the program according to Embodiment 3, the storage unit (corresponding to the damage information detection device-side storage unit 67) stores product information for specifying the refrigeration cycle device 40, and in a case where it is determined that the refrigeration cycle device 40 is damaged, the determination unit 86 determines the damage amount of the refrigeration cycle device 40 from the product information in the first step, and the notification unit 107 provides notification of the damage amount in the second step. With this additional configuration, the information processing method and the program according to Embodiment 3 achieve an effect capable of quickly calculating the damage amount in a case where the refrigeration cycle device is damaged.

In addition, as the additional configuration, in the information processing method and the program according to Embodiment 3, the storage unit (corresponding to the damage information detection device-side storage unit 67) stores home appliance information for specifying a home appliance that is installed inside the building 200 and an installation height of the home appliance associated with the home appliance information, the reception unit (corresponding to the server-side transmission and reception unit 25) acquires an inundation height in an area including the building 200 in a case where the disaster information includes inundation damage information, the determination unit 86 determines the damage amount of the home appliance from the home appliance information in which the installation height associated with the home appliance information stored in the storage unit is less than the inundation height in the first step, and the notification unit 107 provides notification of the damage amount in the second step. With this additional configuration, the information processing method and the program according to Embodiment 3 achieve an effect capable of quickly calculating the damage amount in a case where the inundation damage occurs.

In Embodiment 3, the pre-registration is performed by registering the information on the address of the building, registering each home appliance information of the building, and registering the installation height of each home appliance, but the present disclosure is not limited thereto. For example, a configuration may be adopted in which a floor plan of a house is registered and a home appliance for each room is registered. This is because it is considered that an inundation damage occurs in each room.

In addition, in Embodiment 3, the configuration is adopted in which the home appliance information and the installation height are acquired after the inundation height is acquired, but the present disclosure is not limited thereto. A configuration may be adopted in which the inundation height is acquired after the home appliance information and the installation height are acquired.

In addition, in Embodiment 3, the damage amount display unit displays both the damage amount related to the home appliance and the damage amount related to the refrigeration cycle device, but the present disclosure is not limited thereto. A configuration may be adopted in which the damage amount of only the home appliances is displayed.

In addition, in Embodiment 3, the damage amount display unit displays the damage amount of each home appliance and the total amount of damage amounts, but the present disclosure is not limited thereto. Only the damage amount of each home appliance may be shown, or only the total amount of damage amounts may be displayed.

In addition, in Embodiment 3, the price of the product itself is used as the home appliance information, but the present disclosure is not limited thereto. For example, a configuration may be adopted in which the user inputs the year of purchase or the year of installation of the home appliance in a case of performing the pre-registration, and this information may be used. In that case, the longer the time for installing the home appliance, the smaller the damage amount.

In addition, Embodiment 3 has the configuration in which only the inundation damage is assumed, but the present disclosure is not limited thereto. For example, a configuration may be adopted in which the damage amount caused by a lightning strike is calculated. In that case, disaster information on the lightning strike includes information on a position of the lightning strike, and the information on the position of the building and the information on the position of the lightning strike are compared with each other. In a case where it is determined that the lightning strike occurs at the location including a building, it is estimated that all the indoor devices are damaged, and the damage amount is calculated.

In addition, in Embodiment 3, the damage information detection device-side storage unit stores data in which the home appliance information and the installation height are associated with each other, but the present disclosure is not limited thereto. The server-side storage unit may store the data in which the home appliance information and the installation height are associated with each other.

### Embodiment 4

A damage information detection system 800 according to Embodiment 4 will be described. As compared with Embodiment 1, the damage information detection system 800 according to Embodiment 4 is different in that not only a notification to the notification unit 37 but also control on a refrigeration cycle device 120 is performed. Since a configuration except for the configuration of performing the control on the refrigeration cycle device 120 has the same manner as the configuration of Embodiment 1, the description thereof will be omitted.

In a case where it is determined that the refrigeration cycle device 120 is damaged, the damage information detection system 800 sets an operation of the refrigeration cycle device 120 to a disaster mode which is different from a normal mode. Control on the refrigeration cycle device 120 of invalidating any one or more functions of a cooling function, a dehumidification function, or a heating function, stopping an operation or invalidating driving for the operation, and suppressing a fan rotation speed of the outdoor air blowing device 105 to be less than usual is an exemplary example of the disaster mode. With such a configuration, it is possible to suppress a secondary damage due to a damage or a failure of the refrigeration cycle device 120, and it is possible to use the refrigeration cycle device 120 in a limited manner even at a disaster.

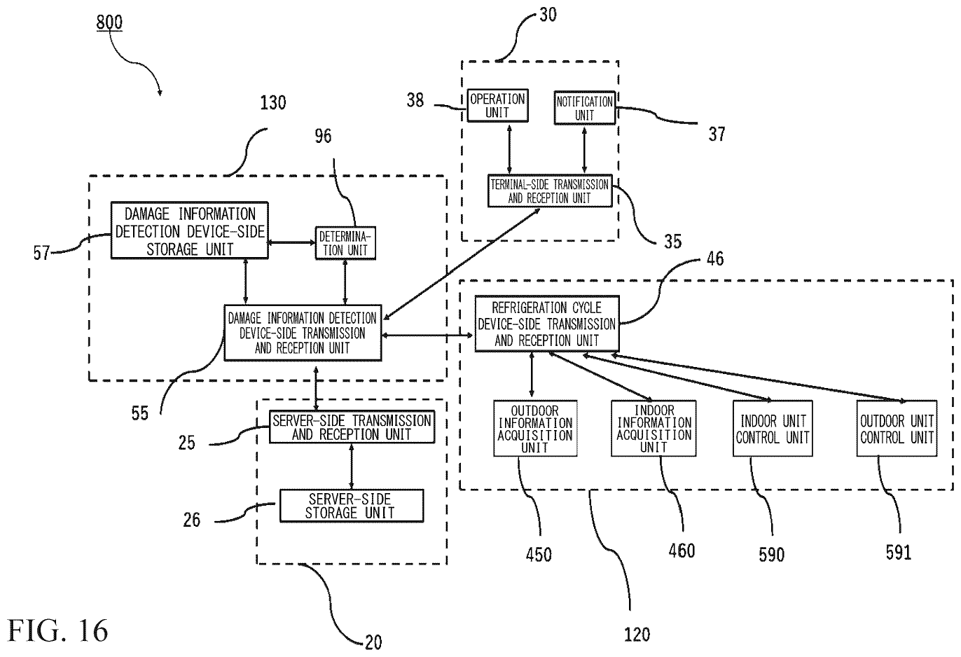

FIG. 16 is a block diagram showing a functional configuration of a damage information detection system 800 according to Embodiment 4. The functional configuration of the damage information detection system 800 will be described with reference to FIG. 16.

As compared with the hardware configuration of the damage information detection system 800, a hardware configuration of the damage information detection system 800 is different in that a process performed by a determination unit 96 is different. In addition, the damage information detection system 800 is different in that a refrigeration cycle device-side transmission and reception unit 46 is provided. In addition, as compared with the hardware configuration of Embodiment 1, the hardware configuration of the damage information detection system 800 is different in that a configuration of an indoor unit control unit 590 and an outdoor unit control unit 591 is provided. Since a hardware configuration obtained by excluding the process performed by the determination unit 96, and the configuration of the refrigeration cycle device-side transmission and reception unit 46, the indoor unit control unit 590, and the outdoor unit control unit 591 has the same manner as the hardware configuration of the damage information detection system 800, the description thereof will be omitted.

The determination unit 96 determines a content to be notified by the notification unit 37 and a control command to the refrigeration cycle device 120. The determination of the content to be notified by the notification unit 37 has the same manner as Embodiment 1, and thus the description thereof will be omitted. The determination unit 96 transmits a signal for changing to a disaster mode which is different from a normal mode, to the indoor unit control unit 590 and the outdoor unit control unit 591. The determination unit 96 is realized by the processor 51 and the memory 52 of the damage information detection device 50.

The refrigeration cycle device-side transmission and reception unit 46 acquires refrigeration cycle device information from the outdoor information acquisition unit 450 and the indoor information acquisition unit 460, and transmits the refrigeration cycle device information to the damage information detection device 130. In addition, the refrigeration cycle device-side transmission and reception unit 46 receives a signal including the control command determined by the determination unit 96 from the damage information detection device-side transmission and reception unit 55. The refrigeration cycle device-side transmission and reception unit 46 transmits a signal including the received control command to the indoor unit control unit 590 and the outdoor unit control unit 591. More specifically, in a case where the received control command is a control command related to the indoor unit 900, the refrigeration cycle device-side transmission and reception unit 46 transmits the signal including the control command to the indoor unit control unit 590. In a case where the received control command is a control command related to the outdoor unit 910, the refrigeration cycle device-side transmission and reception unit 46 transmits the signal including the control command to the outdoor unit control unit 591. The refrigeration cycle device-side transmission and reception unit 46 is realized by the hardware interface 43 of the refrigeration cycle device 120.

The indoor unit control unit 590 and the outdoor unit control unit 591 receive the signal including the control command determined by the determination unit 96. In a case where the signal including the control command for the indoor unit 900 is received, the indoor unit control unit 590 controls the indoor unit 900 in accordance with the control command. In addition, in a case where the signal including the control command for the outdoor unit 910 is received, the outdoor unit control unit 591 controls the outdoor unit 410 in accordance with the control command.

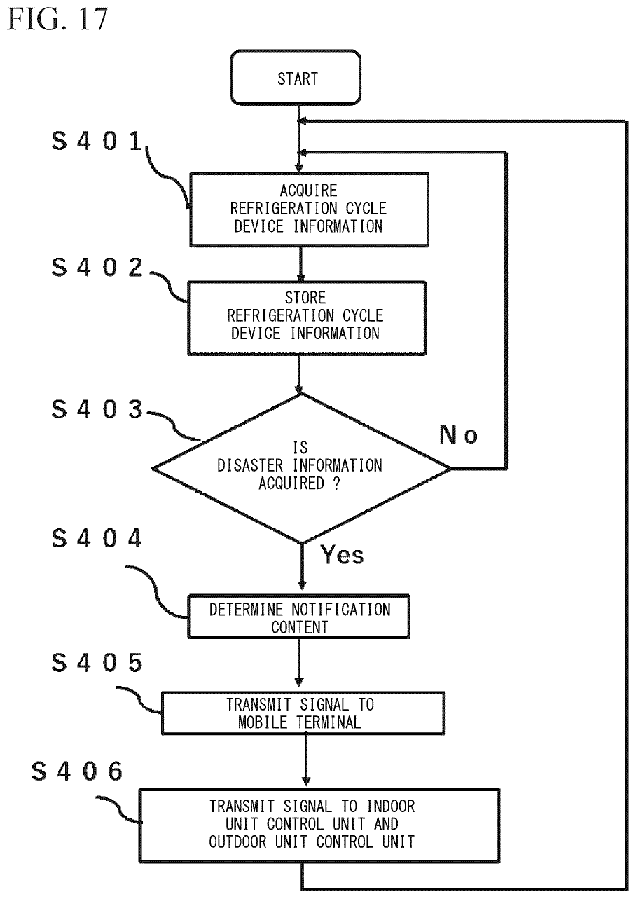

FIG. 17 is a flowchart showing a process performed by the damage information detection device 130 included in the damage information detection system 800 according to Embodiment 4. The process performed by the damage information detection device 130 will be described with reference to FIG. 17. Since steps S401 to S405 are the same as the processes in steps S101 to S105 in Embodiment 1, the description thereof will be omitted.

In step S406, a process is performed after the process in step S405. In step S406, the damage information detection device-side transmission and reception unit 55 transmits a signal for changing to a disaster mode which is different from a normal mode, to the indoor unit control unit 590 and the outdoor unit control unit 591. For example, the determination unit 96 sets a rotation speed of a fan in the outdoor air blowing device 105 to half of a rotation speed in normal operation. In step S406, in a case where the signal is transmitted to a mobile terminal, the process is ended.

After the process in step S406, the damage information detection device-side transmission and reception unit 55 executes step S401.

As described above, an information processing system (corresponding to the damage information detection system 800) according to Embodiment 4 includes a refrigeration cycle device information acquisition unit (corresponding to the outdoor information acquisition unit 450 and the indoor information acquisition unit 460) that acquires refrigeration cycle device information acquired from the refrigeration cycle device 120 having the indoor unit 900 fixed inside the building 200 and the outdoor unit 910 fixed outside the building 200, a storage unit (corresponding to the damage information detection device-side storage unit 57) that stores a value indicating a reference range of data for each refrigeration cycle device information, a reception unit (corresponding to the server-side transmission and reception unit 25) that receives disaster information for notifying that a disaster is occurring at a location at which the refrigeration cycle device 120 is installed, the determination unit 96 that determines, in a case where the disaster information is received by the reception unit, whether the acquired refrigeration cycle device information is data included in the reference range stored in the storage unit to estimate damage information of the refrigeration cycle device 120 and the inside of the building 200, and determines a notification content, and the notification unit 37 that notifies the notification content determined by the determination unit 96. With this configuration, the information processing system according to Embodiment 4 achieves the same effect as the effect described in Embodiment 1.

In addition, an information processing device (corresponding to the damage information detection device 130) according to Embodiment 4 includes a reception unit (corresponding to the damage information detection device-side transmission and reception unit 55) that receives disaster information for notifying that a disaster is occurring at a location at which the refrigeration cycle device 120 is installed, the refrigeration cycle device 120 having the indoor unit 900 fixed inside the building 200 and the outdoor unit 910 fixed outside the building 200, and refrigeration cycle device information acquired from the refrigeration cycle device, a storage unit (corresponding to the damage information detection device-side storage unit 57) that stores a value indicating a reference range of data for each refrigeration cycle device information, the determination unit 96 that determines whether the disaster information and the refrigeration cycle device information received by the reception unit are data included in the reference range stored in the storage unit to estimate damage information of the refrigeration cycle device 120 and the inside of the building 200, and determines a notification content, and a transmission unit (corresponding to the damage information detection device-side transmission and reception unit 55) that transmits a signal for providing notification of the notification content determined by the determination unit 96, to the notification unit 37 that provides notification of the notification content. With this configuration, the information processing device according to Embodiment 4 achieves the same effect as the effect described in Embodiment 1.

In addition, an information processing method according to Embodiment 4 includes a first step in which the determination unit 96 determines, in a case where disaster information for notifying that a disaster is occurring is issued, whether refrigeration cycle device information acquired from the refrigeration cycle device 120 having the indoor unit 900 fixed inside the building 200 and the outdoor unit 910 fixed outside the building 200 is data included in a reference range stored in a storage unit (corresponding to the damage information detection device-side storage unit 57) to estimate damage information of the refrigeration cycle device 120 and the inside of the building 200, and determines a notification content, and a second step in which the notification unit 37 provides notification of the notification content determined in the first step. With this configuration, the information processing method according to Embodiment 4 achieves the same effect as the effect described in Embodiment 1.

In addition, a program according to Embodiment 4 causes a computer to execute a first step in which the determination unit 96 determines, in a case where disaster information for notifying that a disaster is occurring is issued, whether refrigeration cycle device information acquired from the refrigeration cycle device 120 having the indoor unit 900 fixed inside the building 200 and the outdoor unit 910 fixed outside the building 200 is data included in a reference range stored in a storage unit (corresponding to the damage information detection device-side storage unit 57) to estimate damage information of the refrigeration cycle device 120 and the inside of the building 200, and determines a notification content, and a second step in which the notification unit 37 provides notification of the notification content determined in the first step. With this configuration, the program according to Embodiment 4 achieves the same effect as the effect described in Embodiment 1.

In addition, as an additional configuration, the information processing system (corresponding to the damage information detection system 800) according to Embodiment 4 further includes the indoor unit control unit 590 that controls the indoor unit 900, and the outdoor unit control unit 591 that controls the outdoor unit 910, and in a case where the acquired refrigeration cycle device information is data that is not included in a reference range stored in the storage unit (corresponding to the damage information detection device-side storage unit 57), the determination unit 96 transmits a signal for changing to a predetermined disaster mode which is different from a normal mode, to the indoor unit control unit 590 and the outdoor unit control unit 591. With this additional configuration, the information processing system according to Embodiment 4 achieves an effect capable of suppressing a secondary damage due to a damage or a failure of the refrigeration cycle device 120, and using the refrigeration cycle device 120 in a limited manner even at a disaster.

In addition, as the additional configuration, in the information processing system according to Embodiment 4 (corresponding to the damage information detection system 800), the disaster mode includes at least one of control of invalidating any one or more functions of a cooling function, a dehumidification function, or a heating function, control of stopping an operation or invalidating handling for the operation, or control of suppressing a fan rotation speed of the outdoor air blowing device 105 to be less than usual. With this additional configuration, the information processing system according to Embodiment 4 achieves an effect capable of operating the refrigeration cycle device in a limited manner according to the disaster.

In addition, in the information processing method and the program according to Embodiment 4, in the first step, in a case where the acquired refrigeration cycle device information is data that is not included in a reference range stored in the storage unit (corresponding to the damage information detection device-side storage unit 57), the determination unit 96 transmits a signal for changing to a predetermined disaster mode which is different from a normal mode, to the indoor unit control unit 590 and the outdoor unit control unit 591. With this additional configuration, the information processing method and the program according to Embodiment 4 achieve an effect capable of suppressing a secondary damage due to a damage or a failure of the refrigeration cycle device 120, and using the refrigeration cycle device 120 in a limited manner even at a disaster.

In addition, as the additional configuration, in the information processing method and the program according to Embodiment 4, the disaster mode includes at least one of control of invalidating any one or more functions of a cooling function, a dehumidification function, or a heating function, control of stopping an operation or invalidating handling for the operation, or control of suppressing a fan rotation speed of the outdoor air blowing device 105 to be less than usual. With this additional configuration, the information processing method and the program according to Embodiment 4 achieve an effect capable of operating the refrigeration cycle device in a limited manner according to the disaster.

In Embodiment 4, in a case where it is determined that the refrigeration cycle device is damaged, the refrigeration cycle device is controlled by a predetermined control command, but the present disclosure is not limited thereto. For example, the determination unit may change the control command according to the type of the acquired disaster information.

### Embodiment 5

A damage information detection system 1000 according to Embodiment 5 will be described. As compared with Embodiment 1, the damage information detection system 1000 according to Embodiment 5 is different in that a method of estimating damage information of the refrigeration cycle device 40 performed by a determination unit 106. More specifically, in Embodiment 5, the presence or absence of the damage information of the refrigeration cycle device 40 is estimated by using a learned model created by artificial intelligence (AI). The determination unit 106 in Embodiment 5 includes a learning device 140, a damage information detection device-side storage unit 170, and an inference device 190. With such a configuration, it is possible to estimate the damage information with higher accuracy. Since a configuration obtained by excluding the estimation method of the damage information has the same manner as the configuration of Embodiment 1, the description thereof will be omitted.

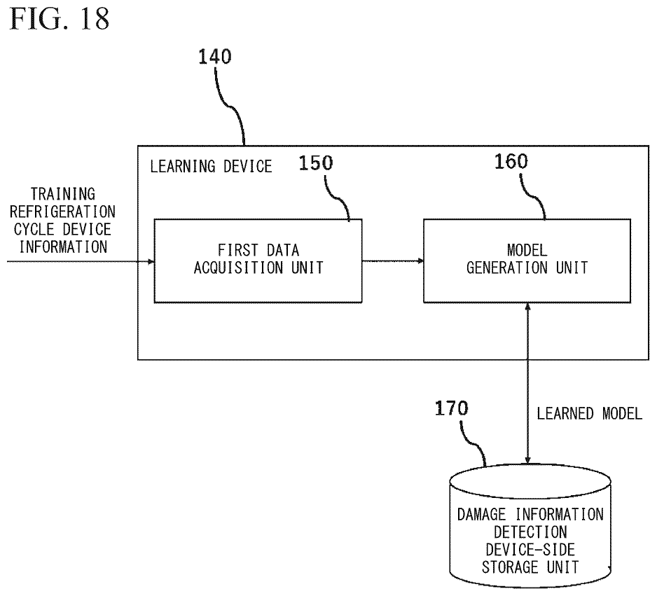

FIG. 18 is a configuration diagram of the learning device 140 and the damage information detection device-side storage unit 170 incorporated in a damage information detection device 180 in the damage information detection system 1000 according to Embodiment 5. A configuration of the learning device 140 and the damage information detection device-side storage unit 170 will be described with reference to FIG. 18.

The learning device 140 includes a first data acquisition unit 150 and a model generation unit 160. The first data acquisition unit 150 acquires training refrigeration cycle device information as training data. The training refrigeration cycle device information is refrigeration cycle device information in a case where the refrigeration cycle device 40 is not damaged. For example, the training refrigeration cycle device information is a voltage value of a fan in the outdoor air blowing device 105 in a case where the refrigeration cycle device 40 is not damaged, the temperature of a refrigerant discharged from the compressor 102, the temperature of a refrigerant in a pipe between the decompression device 103 and the outdoor heat exchanger 104, and a voltage value of a fan in the indoor air blowing device 202.

The model generation unit 160 is trained with a reference range of the refrigeration cycle device information acquired from the refrigeration cycle device 40, based on training data created based on the training refrigeration cycle device information output from the first data acquisition unit 150. That is, a learned model that infers the reference range of the refrigeration cycle device information acquired by the refrigeration cycle device 40 is generated, from the training refrigeration cycle device information of the damage information detection system 1000. Here, the training data is training refrigeration cycle device information. Specifically, the model generation unit 160 generates a model for classifying (clustering) training refrigeration cycle device information in a case where the refrigeration cycle device 40 is not damaged and training refrigeration cycle device information in a case where the refrigeration cycle device 40 is damaged.

A known algorithm such as supervised learning, unsupervised learning, or reinforcement learning can be used as a learning algorithm used by the model generation unit 160. As an example, a case where a K-means method (clustering), which is unsupervised learning, is applied will be described. The unsupervised learning refers to a method of learning a feature in training data by providing training data that does not include a result (label) to the learning device 140.

The model generation unit 160 is trained with a reference range of the refrigeration cycle device information acquired from the refrigeration cycle device 40 by, for example, a so-called unsupervised learning according to a grouping method using a K-means method.

The K-means method is an algorithm of non-hierarchical clustering, and is a method of classifying the given number of clusters into k, by using an average of the clusters.

Specifically, the K-means method is processed in the following flow. First, clusters are randomly allocated to each data xi. Next, a center Vj of each cluster is calculated based on the allocated data. Next, a distance between each xi and each Vj is obtained, and xi is re-allocated to a cluster closest to the center. Then, in a case where the allocation of all the clusters of the xi is not changed in the above process, or in a case where the amount of change falls below a certain threshold value set in advance, it is determined that the process converges, and the process is ended.

In the present disclosure, the reference range of the refrigeration cycle device information acquired from the refrigeration cycle device 40 is trained by so-called unsupervised learning, according to the training data created based on the training refrigeration cycle device information acquired by the first data acquisition unit 150.

The model generation unit 160 generates and outputs the learned model by executing the learning above.

The damage information detection device-side storage unit 170 stores the learned model output from the model generation unit 160.

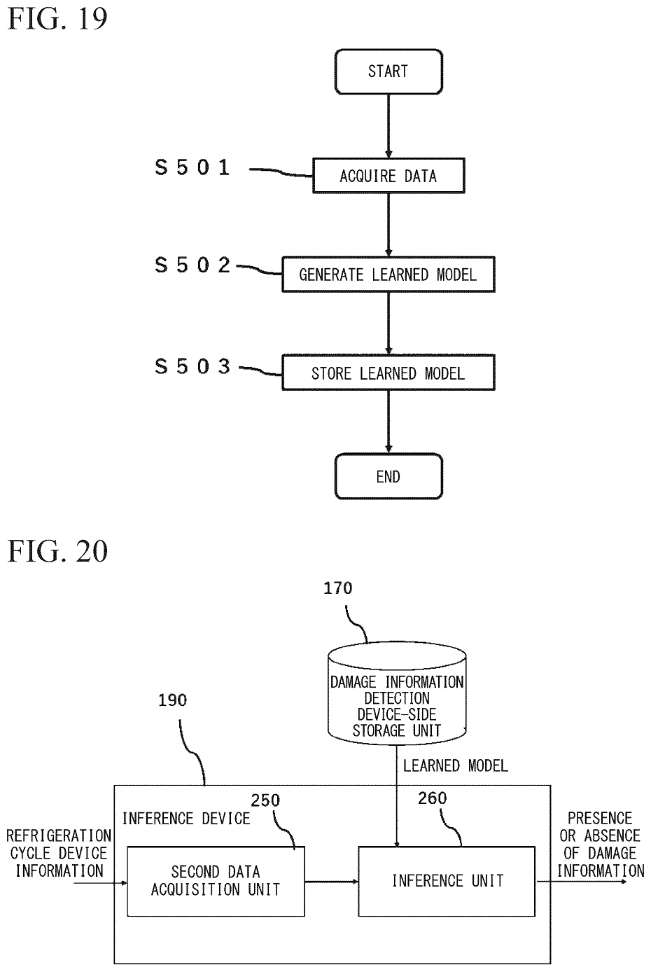

FIG. 19 is a flowchart related to a learning process of a learning device in Embodiment 5. A process with which the learning device 140 performs learning will be described with reference to FIG. 19.

In step S501, the first data acquisition unit 150 acquires training refrigeration cycle device information. In step S501, in a case where the training refrigeration cycle device information is acquired, the process is ended.

In step S502, a process is performed after the process in step S501. In step S502, the model generation unit 160 is trained with a reference range of refrigeration cycle device information acquired from the refrigeration cycle device 40 according to training data created based on the training refrigeration cycle device information acquired in step S501, and generates a learned model by so-called unsupervised learning. In step S502, in a case where the learned model is generated, the process is ended.

In step S503, a process is performed after the process in step S502. In step S503, the damage information detection device-side storage unit 170 stores the learned model generated in step S502. In step S503, in a case where the learned model is stored, the process is ended.

FIG. 20 is a configuration diagram of the inference device 190 related to the damage information detection system 1000. The inference device 190 includes a second data acquisition unit 250 and an inference unit 260.

The second data acquisition unit 250 acquires refrigeration cycle device information and disaster information.

The inference unit 260 infers a reference range of refrigeration cycle device information obtained by using a learned model stored in the damage information detection device-side storage unit 170. That is, in a case where the disaster information is acquired, by inputting the refrigeration cycle device information acquired by the second data acquisition unit 250 to the learned model, to which cluster the refrigeration cycle device information belongs can be inferred, and the presence or absence of damage information in the refrigeration cycle device 40 can be output as an inference result. More specifically, the inference unit 260 determines whether the refrigeration cycle device information input to the learned model belongs to a cluster in a case where the refrigeration cycle device 40 is damaged or belongs to a cluster in a case where the refrigeration cycle device 40 is not damaged. Then, in a case where the refrigeration cycle device information belongs to the cluster in a case where the refrigeration cycle device 40 is damaged, the inference unit 260 infers that the refrigeration cycle device 40 is damaged, on the assumption that the refrigeration cycle device information is not included in the reference range. On the other hand, in a case where the refrigeration cycle device information belongs to the cluster in a case where the refrigeration cycle device 40 is not damaged, the inference unit 260 infers that the refrigeration cycle device 40 is not damaged, on the assumption that the refrigeration cycle device information is included in the reference range.

In this manner, the inference unit 260 outputs the presence or absence of the damage information in the refrigeration cycle device 40 obtained based on the refrigeration cycle device information and the disaster information, to the notification unit 37 of the damage information detection system 1000.

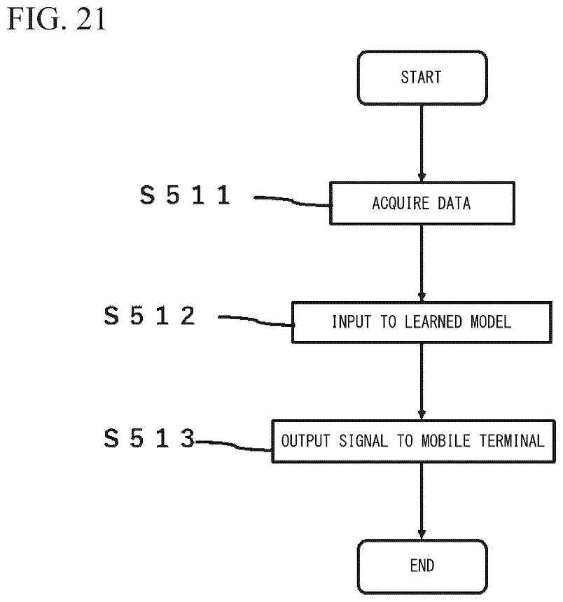

FIG. 21 is a flowchart related to an inference process of the inference device 190 in the damage information detection system 1000 according to Embodiment 5. The inference process performed by the inference device 190 will be described with reference to FIG. 21.

In step S511, the second data acquisition unit 250 acquires refrigeration cycle device information and disaster information. In step S511, in a case where the refrigeration cycle device information and the disaster information are acquired, the process is ended.

In step S512, a process is performed after the process in step S511. In step S512, the inference unit 260 acquires a learned model from the damage information detection device-side storage unit 170, inputs the refrigeration cycle device information to the acquired learned model, and obtains the presence or absence of damage information in the refrigeration cycle device 40. In step S512, in a case where the refrigeration cycle device information is input to the learned model, the process is ended.

In step S513, a process is performed after the process in step S512. In step S513, the damage information detection device-side transmission and reception unit 55 transmits a signal for notifying the mobile terminal 30 of the presence or absence of the damage information in the refrigeration cycle device 40 obtained by the learned model acquired in step S512. In step S513, in a case where the signal is transmitted to the mobile terminal 30, the process is ended.

As described above, an information processing system (corresponding to the damage information detection system 1000) according to Embodiment 5 includes a refrigeration cycle device information acquisition unit (corresponding to the outdoor information acquisition unit 450 and the indoor information acquisition unit 460) that acquires refrigeration cycle device information acquired from the refrigeration cycle device 40 having the indoor unit 400 fixed inside the building 200 and the outdoor unit 410 fixed outside the building 200, a storage unit (corresponding to the damage information detection device-side storage unit 170) that stores a reference range of data for each refrigeration cycle device information, a reception unit (corresponding to the server-side transmission and reception unit 25) that receives disaster information for notifying that a disaster is occurring at a location at which the refrigeration cycle device 40 is installed, the determination unit 106 that determines, in a case where the disaster information is received by the reception unit, whether the acquired refrigeration cycle device information is data included in the reference range stored in the storage unit to estimate damage information of the refrigeration cycle device 40 and the inside of the building 200, and determines a notification content, and the notification unit 37 that notifies the notification content determined by the determination unit 106. With this configuration, the information processing system according to Embodiment 5 achieves the same effect as the effect described in Embodiment 1.

In addition, an information processing device (corresponding to the damage information detection device 130) according to Embodiment 5 includes a reception unit (corresponding to the damage information detection device-side transmission and reception unit 55) that receives disaster information for notifying that a disaster is occurring at a location at which the refrigeration cycle device 40 having the indoor unit 400 fixed inside the building 200 and the outdoor unit 410 fixed outside the building 200 is installed, and refrigeration cycle device information acquired from the refrigeration cycle device 40, a storage unit (corresponding to the damage information detection device-side storage unit 170) that stores a value indicating a reference range of data for each refrigeration cycle device information, the determination unit 106 that determines whether the disaster information and the refrigeration cycle device information received by the reception unit are data included in the reference range stored in the storage unit to estimate damage information of the refrigeration cycle device 40 and the inside of the building 200, and determines a notification content, and a transmission unit (corresponding to the damage information detection device-side transmission and reception unit 55) that transmits a signal for providing notification of the notification content determined by the determination unit 106, to the notification unit 37 that provides notification of the notification content. With this configuration, the information processing device according to Embodiment 5 achieves the same effect as the effect described in Embodiment 1.

In addition, an information processing method according to Embodiment 5 includes a first step in which the determination unit 106 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 170) to estimate damage information of the refrigeration cycle device 40 and the inside of the building 200, and determines a notification content, and a second step in which the notification unit 37 provides notification of the notification content determined in the first step. With this configuration, the information processing method according to Embodiment 5 achieves the same effect as the effect described in Embodiment 1.

In addition, a program according to Embodiment 5 causes a computer to execute a first step in which the determination unit 106 determines, in a case where disaster information for notifying that a disaster is occurring is issued, whether refrigeration cycle device information acquired from the refrigeration cycle device 40 having the indoor unit 400 fixed inside the building 200 and the outdoor unit 410 fixed outside the building 200 is data included in a reference range stored in a storage unit (corresponding to the damage information detection device-side storage unit 170) to estimate damage information of the refrigeration cycle device 40 and the inside of the building 200, and determines a notification content, and a second step in which the notification unit 37 provides notification of the notification content determined in the first step. With this configuration, the program according to Embodiment 5 achieves the same effect as the effect described in Embodiment 1.

In addition, as an additional configuration, in the information processing system according to Embodiment 5 (corresponding to the damage information detection system 1000), the reference range is determined by a learned model estimated from training refrigeration cycle device information, which is refrigeration cycle device information in a case where the refrigeration cycle device 40 is not damaged. With this configuration, the information processing system according to Embodiment 5 can estimate the damage information with higher accuracy.

In addition, as an additional configuration, in the information processing device (corresponding to the damage information detection device 130) according to Embodiment 5, the reference range is determined by a learned model estimated from training refrigeration cycle device information, which is refrigeration cycle device information in a case where the refrigeration cycle device 40 is not damaged. With this configuration, the information processing device according to Embodiment 5 can estimate the damage information with higher accuracy.

In addition, as an additional configuration, in the information processing method and the program according to Embodiment 5, the reference range is determined by a learned model estimated from training refrigeration cycle device information, which is refrigeration cycle device information in a case where the refrigeration cycle device 40 is not damaged. With this configuration, the information processing method and the program according to Embodiment 5 can estimate the damage information with higher accuracy.

In Embodiment 5, a case where the unsupervised learning is applied to the learning algorithm used by the model generation unit and the inference unit is described, but the present disclosure is not limited thereto. For the learning algorithm, in addition to the unsupervised learning, reinforcement learning, supervised learning, semi-supervised learning, and the like can be applied.

In addition, as a learning algorithm used in the learning unit, deep learning of learning the extraction of the feature amount itself can be used, or another known method may be used.

In addition, in a case of realizing the unsupervised learning in Embodiment 5, the present disclosure is not limited to the non-hierarchical clustering by the k-means method described above, and any other known method capable of performing clustering may be used.

In addition, the model generation unit may perform learning of the presence or absence of damage information in the refrigeration cycle device 40 according to training data created for a plurality of damage information detection systems. The model generation unit may acquire the training data from the plurality of damage information detection systems used in the same area, or may learn the presence or absence of the damage information in the refrigeration cycle device by using the training data collected from the plurality of damage information detection systems that operate independently in different areas. In addition, it is also possible to add or remove the damage information detection system for collecting the training data from the target in the middle. Further, a learning device that is trained with damage information in the refrigeration cycle device for a certain damage information detection system may be applied to another damage information detection system, and the presence or absence of the damage information in the refrigeration cycle device may be re-trained and updated for the other damage information detection system.

In addition, in Embodiment 5, the learning device and the inference device are incorporated in the damage information detection device, but the present disclosure is not limited thereto. For example, the learning device and the inference device may be separate devices or may be present on a cloud server.

In addition, in Embodiment 5, the configuration is adopted in which the reference range of the refrigeration cycle device information is determined only by training refrigeration cycle device information, but the present disclosure is not limited thereto. For example, as a configuration in which training damage information associated with the training refrigeration cycle device information is also acquired, a configuration may be adopted in which a reference range of the refrigeration cycle device information different depending on disaster information is trained.

In addition, in Embodiment 5, the presence or absence of an inundation is determined by comparing the inundation height with the installation height of the home appliance, but the present disclosure is not limited thereto. For example, a configuration may be adopted in which an altitude of the building itself is also registered in advance and taken into consideration.

Although the preferred embodiments are described in detail above, the present disclosure is not limited to the embodiments described above, and various modifications and substitutions can be made to the embodiments described above without departing from the claims.

### REFERENCE SIGNS LIST

20 Server
21 Processor
22 Memory
23 Hardware interface
24 Storage
25 Server-side transmission and reception unit
26 Server-side storage unit
30 Mobile terminal
33 Hardware interface
34 Operation device
35 Terminal-side transmission and reception unit
36 Display device
37 Notification unit
38 Operation unit
40 Refrigeration cycle device
41 Processor
42 Memory
43 Hardware interface
45 Refrigeration cycle device-side transmission unit
46 Refrigeration cycle device-side transmission and reception unit
50 Damage information detection device
51 Processor
52 Memory
53 Hardware interface
54 Storage
55 Damage information detection device-side transmission and reception unit
56 Determination unit
57 Damage information detection device-side storage unit
60 Damage information detection device
62 Memory
66 Determination unit
67 Damage information detection device-side storage unit
70 Damage information detection device
76 Determination unit
80 Damage information detection device
86 Determination unit
90 Mobile terminal
96 Determination unit
97 Notification unit
100 Damage information detection system
101 Four-way valve
102 Compressor
103 Decompression device
104 Outdoor heat exchanger
105 Outdoor air blowing device
106 Determination unit
107 Notification unit
110 Mobile terminal
120 Refrigeration cycle device
130 Damage information detection device
140 Learning device
150 First data acquisition unit
160 Model generation unit
170 Damage information detection device-side storage unit
180 Damage information detection device
190 Inference device
200 Building
201 Indoor heat exchanger
202 Indoor air blowing device
250 Second data acquisition unit
260 Inference unit
300 Network
301 Pipe
370 Disaster information display unit
371 Evacuation information display unit
372 House damage information display unit
382 House damage information display unit
390 Evacuation situation display unit
391 Damage amount display unit
400 Indoor unit
410 Outdoor unit
440 First temperature sensor
441 Second temperature sensor
442 First voltage sensor
443 Second voltage sensor
450 Outdoor information acquisition unit
460 Indoor information acquisition unit
490 Indoor unit control unit
491 Outdoor unit control unit
500 Damage information detection system
550 Human sensor
590 Indoor unit control unit
591 Outdoor unit control unit
600 Damage information detection system
700 Damage information detection system
800 Damage information detection system
900 Indoor unit
910 Outdoor unit
1000 Damage information detection system

1-14. (canceled)

15. An information processing system comprising:
refrigeration cycle device information acquisition circuitry to acquire refrigeration cycle device information acquired from a refrigeration cycle device having indoor circuitry fixed inside a building and outdoor circuitry fixed outside the building;
storage circuitry to store a reference range of data for each refrigeration cycle device information;
reception circuitry to receive disaster information for notifying that a disaster is occurring at a location at which the refrigeration cycle device is installed;
determination circuitry to determine, in a case where the disaster information is received by the reception circuitry, whether the acquired refrigeration cycle device information is data included in the reference range stored in the storage circuitry to estimate damage information of the refrigeration cycle device and the inside of the building, and determine a notification content; and
notification circuitry to provide notification of the notification content determined by the determination circuitry,
wherein the refrigeration cycle device information includes two or more types of information, and one type of information of the refrigeration cycle device is set as primary reference data and information other than the primary reference data is set as secondary reference data, and
in a case where the primary reference data is included in the reference range stored in the storage circuitry, the determination circuitry determines whether the secondary reference data is included in each reference range, and determines that the refrigeration cycle device is damaged in a case where there is the secondary reference data which is not included in the reference range.

16. An information processing system comprising:
refrigeration cycle device information acquisition circuitry to acquire refrigeration cycle device information acquired from a refrigeration cycle device having indoor circuitry fixed inside a building and outdoor circuitry fixed outside the building;
storage circuitry to store a reference range of data for each refrigeration cycle device information;
reception circuitry to receive disaster information for notifying that a disaster is occurring at a location at which the refrigeration cycle device is installed;
determination circuitry to determine, in a case where the disaster information is received by the reception circuitry, whether the acquired refrigeration cycle device information is data included in the reference range stored in the storage circuitry to estimate damage information of the refrigeration cycle device and the inside of the building, and determine a notification content; and
notification circuitry to provide notification of the notification content determined by the determination circuitry;
indoor circuitry control circuitry to control the indoor circuitry; and
outdoor circuitry control circuitry to control the outdoor circuitry,
wherein in a case where the acquired refrigeration cycle device information is data that is not included in the reference range stored in the storage circuitry, the determination circuitry transmits a signal for changing to a predetermined disaster mode which is different from a normal mode, to the indoor circuitry control circuitry and the outdoor circuitry control circuitry, and
the disaster mode includes control of suppressing a fan rotation speed of an outdoor air blowing device to be less than usual.

17. The information processing system according to claim 15,
wherein the refrigeration cycle device information includes outdoor information indicating information on a space in which the outdoor circuitry is installed.

18. The information processing system according to claim 16,
wherein the refrigeration cycle device information includes outdoor information indicating information on a space in which the outdoor circuitry is installed.

19. The information processing system according to claim 17,
wherein the outdoor circuitry includes a compressor, an outdoor heat exchanger, an outdoor air blowing device that blows an outdoor air to the outdoor heat exchanger, and a decompression device, and
the outdoor information includes at least one information of temperature of a refrigerant discharged from the compressor, a voltage value of a motor in the outdoor air blowing device, or temperature of a refrigerant in a pipe connecting the decompression device and the outdoor heat exchanger.

20. The information processing system according to claim 18,
wherein the outdoor circuitry includes a compressor, an outdoor heat exchanger, an outdoor air blowing device that blows an outdoor air to the outdoor heat exchanger, and a decompression device, and
the outdoor information includes at least one information of temperature of a refrigerant discharged from the compressor, a voltage value of a motor in the outdoor air blowing device, or temperature of a refrigerant in a pipe connecting the decompression device and the outdoor heat exchanger.

21. The information processing system according to claim 15,
wherein the storage circuitry stores product information for specifying the refrigeration cycle device, and
in a case where it is determined that the refrigeration cycle device is damaged, the determination circuitry determines a damage amount of the refrigeration cycle device from the product information, and
the notification circuitry provides notification of the damage amount.

22. The information processing system according to claim 21,
wherein the storage circuitry stores home appliance information for specifying a home appliance installed inside the building and an installation height of the home appliance associated with the home appliance information,
the reception circuitry acquires an inundation height in an area including the building in a case where the disaster information includes inundation damage information,
the determination circuitry determines a damage amount of the home appliance from the home appliance information in which the associated installation height is less than the inundation height, among the home appliance information stored in the storage circuitry, and
the notification circuitry provides notification of the damage amount.

23. The information processing system according to claim 15,
wherein the refrigeration cycle device information includes in-person determination information for determining whether a person is present inside the building, and
in a case where the reception circuitry receives evacuation information at a location at which the refrigeration cycle device is installed and the in-person determination information is information indicating that the person is present inside the building, the notification circuitry provides notification of the evacuation information for notifying that the person is present inside.

24. The information processing system according to claim 16,
wherein the refrigeration cycle device information includes in-person determination information for determining whether a person is present inside the building, and
in a case where the reception circuitry receives evacuation information at a location at which the refrigeration cycle device is installed and the in-person determination information is information indicating that the person is present inside the building, the notification circuitry provides notification of the evacuation information for notifying that the person is present inside.

25. The information processing system according to claim 15,
wherein the reference range is determined by a learned model estimated from training refrigeration cycle device information that is refrigeration cycle device information in a case where the refrigeration cycle device is not damaged.

26. The information processing system according to claim 16,
wherein the reference range is determined by a learned model estimated from training refrigeration cycle device information that is refrigeration cycle device information in a case where the refrigeration cycle device is not damaged.

27. An information processing device comprising:
reception circuitry to receive disaster information for notifying that a disaster is occurring at a location at which a refrigeration cycle device including indoor circuitry fixed inside a building and outdoor circuitry fixed outside the building is installed, and refrigeration cycle device information acquired from the refrigeration cycle device;
storage circuitry to store a value indicating a reference range of data for each refrigeration cycle device information;
determination circuitry to determine whether the disaster information and the refrigeration cycle device information received by the reception circuitry are data included in the reference range stored in the storage circuitry to estimate damage information of the refrigeration cycle device and the inside of the building, and determine a notification content; and
transmission circuitry to transmit a signal for providing notification of the notification content determined by the determination circuitry, to notification circuitry that provides notification of the notification content,
wherein the refrigeration cycle device information includes two or more types of information, and one type of information of the refrigeration cycle device is set as primary reference data and information other than the primary reference data is set as secondary reference data, and
in a case where the primary reference data is included in the reference range stored in the storage circuitry, the determination circuitry determines whether the secondary reference data is included in each reference range, and determines that the refrigeration cycle device is damaged in a case where there is the secondary reference data which is not included in the reference range.

28. An information processing method comprising:
determining, in a case where disaster information for notifying that a disaster is occurring is issued and in a case where primary reference data that is one type of refrigeration cycle device information including two or more types of information acquired from a refrigeration cycle device having indoor circuitry fixed inside a building and outdoor circuitry fixed outside the building is included in a reference range stored in a storage circuitry, whether secondary reference data that is the refrigeration cycle device information other than the primary reference data is included in each reference range, determining that the refrigeration cycle device is damaged in a case where there is the secondary reference data that is not included in the reference range, and determining a notification content; and
providing notification of the notification content determined in the determining, by notification circuitry.

29. A computer readable non-transitory recording medium having a program causing a computer to execute:
determining, in a case where disaster information for notifying that a disaster is occurring is issued and in a case where primary reference data that is one type of refrigeration cycle device information including two or more types of information acquired from a refrigeration cycle device having indoor circuitry fixed inside a building and outdoor circuitry fixed outside the building is included in a reference range stored in storage circuitry, whether secondary reference data that is the refrigeration cycle device information other than the primary reference data is included in each reference range, determining that the refrigeration cycle device is damaged in a case where there is the secondary reference data that is not included in the reference range, and determining a notification content; and
providing notification of the notification content determined in the determining, by notification circuitry.
